(19) United States
(12) Patent Application Publication
(10) Pub. No.: US 2024/0305154 A1
(43) Pub. Date: Sep. 12, 2024

(54) ARMATURE AND ROTATING ELECTRIC MACHINE

(71) Applicant: DENSO CORPORATION, Kariya-city (JP)

(72) Inventors: Toshio YAMAMOTO, Kariya-city (JP); Yuji HAYASHI, Kariya-city (JP)

(73) Assignee: DENSO CORPORATION, Kariya-city (JP)

(21) Appl. No.: 18/666,400

(22) Filed: May 16, 2024

Related U.S. Application Data
(63) Continuation of application No. PCT/JP2022/031450, filed on Aug. 19, 2022.

(30) Foreign Application Priority Data
Nov. 18, 2021 (JP) 2021-188164

(51) Int. Cl. H02K 3/26; H02K 23/26

(52) U.S. Cl. CPC H02K 3/26; H02K 23/26

(57) ABSTRACT

A stator includes a stator core, a coil assembly and a coil assembly support member. The coil assembly has a band member rolled along a circumferential direction into an annular shape, a coil formed on the band member, and a coil-assembly-side recess formed in the band member. The coil assembly support member is provided between the stator core and the coil assembly and mounted to the stator core. The coil assembly support member has a support-member-side protrusion. The coil assembly is positioned with respect to the stator core through engagement between the support-member-side protrusion and the coil-assembly-side recess.

### CROSS-REFERENCE TO RELATED APPLICATIONS

The present application is a continuation application of International Application No. PCT/JP2022/031450 filed on Aug. 19, 2022, which is based on and claims priority from Japanese Patent Application No. 2021-188164 filed on Nov. 18, 2021. The entire contents of these applications are incorporated by reference into the present application.

### BACKGROUND

### 1 Technical Field

The present disclosure relates to armatures and rotating electric machines.

### 2 Description of Related Art

There is a cylindrical coil disclosed in, for example, Japanese Patent No. JP 5017627 B2. The cylindrical coil has a coil pattern that is formed on a cylindrical substate by: forming a coil pattern groove in an outer surface of the cylindrical substate; and filling the coil pattern groove with an electroconductive material. With this configuration, it is possible to improve the accuracy of roundness and runout of the cylindrical coil. Moreover, in a rotating electric machine that includes the cylindrical coil, it is possible to reduce a magnetic gap, thereby enabling improvement in the output and efficiency of the rotating electric machine.

### SUMMARY

In an armature, which includes a coil assembly (or cylindrical coil) as disclosed in the aforementioned patent document and an armature core, and a rotating electric machine that includes the armature, it is important to secure the positional accuracy of the coil assembly with respect to the armature core while having the coil assembly supported by the armature core.

The present disclosure has been accomplished in view of the above circumstances.

According to a first aspect of the present disclosure, there is provided an armature which includes a tubular armature core, a coil assembly and an engagement member. The coil assembly is arranged along the armature core and has a band member, a coil and a first engagement portion. The band member is formed of an electrically-insulative material into a band shape and rolled along a circumferential direction into an annular shape. The coil is formed of an electroconductive material to the band member. The first engagement portion is provided to the band member. The engagement member is mounted to the armature core. The engagement member has a second engagement portion that engages with the first engagement portion and thereby positions the coil assembly with respect to the armature core. Moreover, according to a second aspect of the present disclosure, there is provided a rotating electric machine which includes the armature.

With the above configuration, it becomes possible to secure the positional accuracy of the coil assembly with respect to the armature core while having the coil assembly supported by the armature core.

### BRIEF DESCRIPTION OF THE DRAWINGS

FIG. 1 is a cross-sectional view, taken along an axial direction, of a motor according to a first embodiment.

FIG. 2 is a cross-sectional view, taken along a radial direction, of the motor according to the first embodiment.

FIG. 3 is a schematic perspective view of a coil assembly.

FIG. 4 is a schematic perspective view of a band member in a rolled state.

FIG. 5 is a diagram illustrating a star connection.

FIG. 6 is a diagram illustrating connection of a plurality of coils.

FIG. 7 is a schematic view of coils.

FIG. 8 is a schematic view showing U-phase coil subgroups offset from each other in the axial direction.

FIG. 9 is a development of the coil assembly.

FIG. 10 is a cross-sectional view of a part of the coil assembly.

FIG. 11 is a cross-sectional view of another part of the coil assembly.

FIG. 12 is a cross-sectional view of yet another part of the coil assembly.

FIG. 13 is a cross-sectional view of the coil assembly taken along a radial direction.

FIG. 14 is a cross-sectional view of a vertical-portion laminate.

FIG. 15 is a cross-sectional view of another vertical-portion laminate.

FIG. 16 is a cross-sectional view of yet another vertical-portion laminate.

FIG. 17 is an exploded perspective view showing the coil assembly and a coil assembly support member.

FIG. 18 is an enlarged perspective view of part of the coil assembly support member.

FIG. 19 is a view, from a radially inner side, of engagement regions where support-member-side protrusions engage with the coil assembly.

FIG. 20 is a cross-sectional view of the motor taken along the radial direction and the axial direction, i.e., taken along the line B-B in FIG. 19.

FIG. 21 is an exploded perspective view showing a stator core and a coil assembly support member of a motor according to a second embodiment.

FIG. 22 is a cross-sectional view, taken along a radial direction and an axial direction, of the motor according to the second embodiment, which corresponds to FIG. 20.

FIG. 23 is an exploded perspective view showing a coil assembly and a coil assembly support member of a motor according to a third embodiment.

FIG. 24 is a view, from a radially inner side, of engagement regions where the coil assembly engages with support-member-side recesses in the motor according to the third embodiment.

FIG. 25 is a cross-sectional view, taken along a radial direction and an axial direction, of the motor according to the third embodiment, which is taken along the line B-B in FIG. 24.

FIG. 26 is a schematic cross-sectional view illustrating the configuration of an insulator of a motor according to a fourth embodiment.

FIG. 27 is an enlarged perspective view of a stator core and a coil assembly support member of a motor according to a fifth embodiment.

FIG. 28 is an exploded perspective view of a coil assembly support member of a motor according to a sixth embodiment.

FIG. 29 is a cross-sectional view, taken along a radial direction and an axial direction, of the motor according to the sixth embodiment, which corresponds to FIG. 20.

FIG. 30 is an exploded perspective view of a coil assembly support member of a motor according to a seventh embodiment.

FIG. 31 is a cross-sectional view, taken along a radial direction and an axial direction, of the motor according to the seventh embodiment, which corresponds to FIG. 20.

FIG. 32 is a schematic diagram illustrating a process of manufacturing a stator core of a motor according to an eighth embodiment.

FIG. 33 is another schematic diagram illustrating the process of manufacturing the stator core of the motor according to the eighth embodiment.

FIG. 34 is an enlarged perspective view of a coil assembly support member of the motor according to the eighth embodiment.

FIG. 35 is a diagram showing, in an enlarged manner, engagement regions where the coil assembly support member and the stator core engage with each other in the motor according to the eighth embodiment.

FIG. 36 is an enlarged perspective view of a coil assembly support member of a motor according to a ninth embodiment.

FIG. 37 is a diagram showing, in an enlarged manner, engagement regions where the coil assembly support member and a stator core engage with each other in the motor according to the ninth embodiment.

FIG. 38 is a perspective view of a coil assembly, a stator core and a coil assembly support member of a motor according to a tenth embodiment.

FIG. 39 is a cross-sectional view, taken along a radial direction and an axial direction, of the motor according to the tenth embodiment, which corresponds to FIG. 20.

FIG. 40 is a perspective view of a coil assembly, a stator core and a coil assembly support member of a motor according to an eleventh embodiment.

FIG. 41 is a cross-sectional view, taken along a radial direction and an axial direction, of the motor according to the eleventh embodiment, which corresponds to FIG. 20.

FIG. 42 is a view, from a radially inner side, of a stator of a motor according to a twelfth embodiment.

FIG. 43 is a cross-sectional view, taken along a radial direction and an axial direction, of a motor according to a thirteenth embodiment.

FIG. 44 is a cross-sectional view, taken along a radial direction and an axial direction, of a motor according to a fourteenth embodiment.

FIG. 45 is a cross-sectional view, taken along a radial direction and an axial direction, of a motor according to a fifteenth embodiment.

FIG. 46 is a schematic diagram showing a coil assembly before being rolled.

FIG. 47 is a diagram illustrating the pitches between coil-assembly-side recesses in different laps of a band member.

FIG. 48 is a schematic perspective view of a coil assembly.

FIG. 49 is a schematic diagram illustrating an initial state of the coil assembly in a process of rolling the coil assembly.

FIG. 50 is a schematic diagram illustrating a final state of the coil assembly in the process of rolling the coil assembly.

FIG. 51 is a schematic diagram illustrating a process of removing the coil assembly from a jig.

FIG. 52 is an enlarged perspective view of a pin of a roller according to a modification.

FIG. 53 is a perspective view of a jig according to another modification.

FIG. 54 is a schematic perspective view of a coil assembly of a motor according to a sixteenth embodiment.

FIG. 55 is a schematic diagram illustrating a process of assembling a plurality of band members together.

FIG. 56 is a cross-sectional view, taken along a radial direction and an axial direction, of a motor according to a seventeenth embodiment, which corresponds to FIG. 20.

FIG. 57 is a cross-sectional view, taken along a radial direction and an axial direction, of a motor according to an eighteenth embodiment, which corresponds to FIG. 20.

### DESCRIPTION OF EMBODIMENTS

### First Embodiment

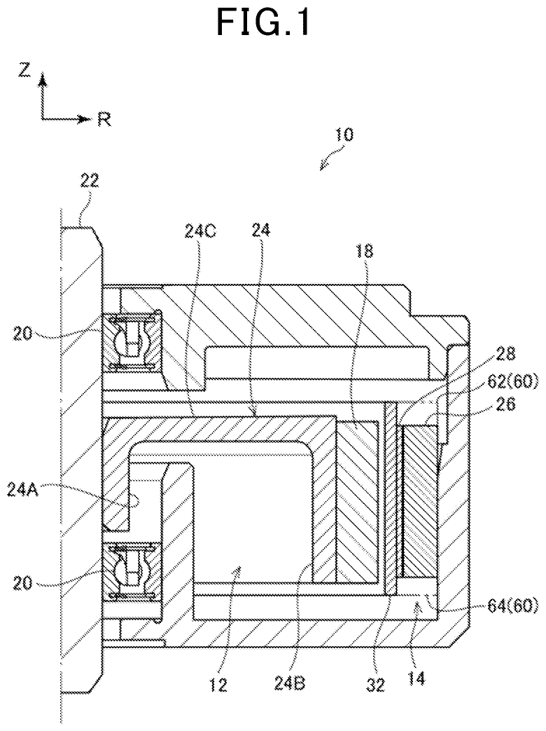

A motor 10 according to the first embodiment of the present disclosure will be described with reference to FIGS. 1 to 20. It should be noted that the arrows Z, R and C suitably shown in the drawings respectively indicate a first side in a rotation axial direction, the outer side in a rotation radial direction and a first side in a rotation circumferential direction of a rotor 12 that will be described later. Moreover, in the case of merely indicating the axial direction, the radial direction and the circumferential direction, unless specified otherwise, the arrows Z, R and C respectively indicate the rotation axial direction, the rotation radial direction and the rotation circumferential direction of the rotor 12. In addition, the motor 10 according to the present embodiment and motors according to embodiments to be described later are examples of rotating electric machines.

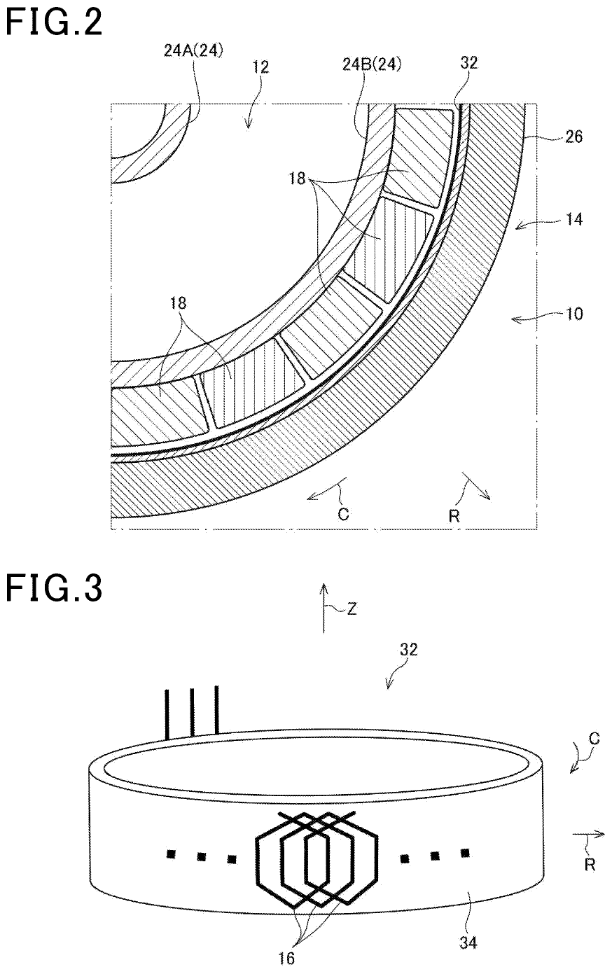

As shown in FIGS. 1 and 2, in the present embodiment, the motor 10 is configured as an inner rotor type brushless motor in which the rotor 12 is arranged radially inside a stator 14 that serves as an armature. It should be noted that: FIGS. 1 and 2 merely illustrate an example of the motor 10; and there may be some inconsistencies in the number of coils 16, the number of magnets 18 and the shapes of details between these figures and the later explanation of the motor 10.

The rotor 12 includes a rotating shaft 22 that is rotatably supported by a pair of bearings 20, a rotor core 24 that is formed in a bottomed cylindrical shape and fixed to the rotating shaft 22, and a plurality of magnets 18 fixed to a radially outer surface of the rotor core 24.

The rotor core 24 has a first cylindrical part 24A fixed onto the rotating shaft 22 by press-fitting or the like, a second cylindrical part 24B located radially outside the first cylindrical part 24A, and a discoid connection plate part 24C that radially connects an end portion of the first cylindrical part 24A on the first side in the axial direction and an end portion of the second cylindrical part 24B on the first side in the axial direction. An outer circumferential surface (i.e., a radially outer surface) of the second cylindrical part 24B is formed as a cylindrical surface along the circumferential direction. To the outer circumferential surface of the second cylindrical part 24B, there are fixed the magnets 18 which will be described later.

The magnets 18 are formed of a magnetic compound whose intrinsic coercive force He is higher than or equal to 400 [kA/m] and whose residual flux density Br is higher than or equal to 1.0[T]. For example, the magnets 18 may be formed of a magnetic compound such as NdFe₁₁TiN, Nd₂Fe₁₄B, Sm₂Fe₁₇N₃ or FeNi. Moreover, as mentioned above, the magnets 18 are fixed to the outer circumferential surface of the second cylindrical part 24B of the rotor core 24. Furthermore, those magnets 18 each of which has a radially outer surface forming an N pole and those magnets 18 each of which has a radially outer surface forming an S pole are arranged alternately in the circumferential direction. In addition, the number of the magnets 18 may be set properly in consideration of the output and the like required of the motor 10.

The stator 14 includes an annular stator core 26 that serves as an armature core, an insulator 28 mounted to the stator core 26 by bonding or fitting, and a coil assembly 32 mounted to the stator core 26 via the insulator 28. Moreover, the stator 14 further includes a coil assembly support member 60 serving as an engagement member, which will be described in detail later. As shown in FIGS. 1 to 3, in the present embodiment, the stator 14 has a toothless structure such that no part of the stator core 26 is arranged inside the coils 16 each constituting a part of the coil assembly 32.

As shown in FIGS. 1 and 2, the stator core 26 is formed of a soft-magnetic material, such as steel, into an annular shape. The stator core 26 is arranged coaxially with the rotor 12; and the axial center position of the stator core 26 coincides in the axial direction with the axial center positions of the magnets 18 fixed to the rotor core 24.

As shown in FIG. 1, the insulator 28 is formed of an electrically-insulative material such as a resin material. In a state of having been mounted to the stator core 26, the insulator 28 covers a radially inner surface of the stator core 26. It should be noted that the insulator 28 is not shown in FIG. 2.

As shown in FIG. 3, the coil assembly 32 according to the present embodiment includes a band member 34 that is formed of an electrically-insulative material into a band shape, and the coils 16 formed on the band member 34.

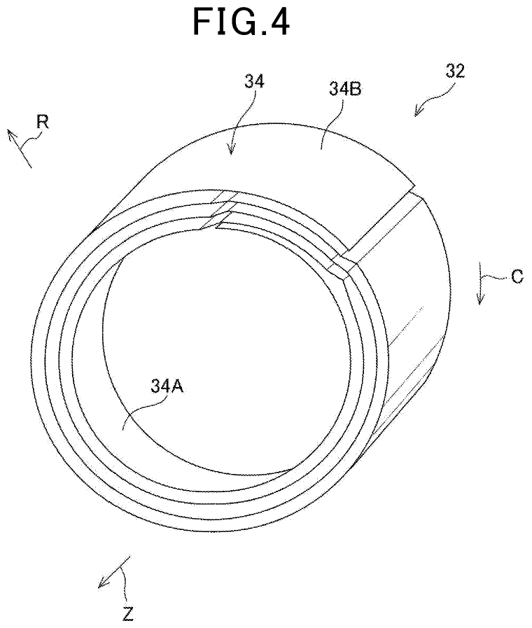

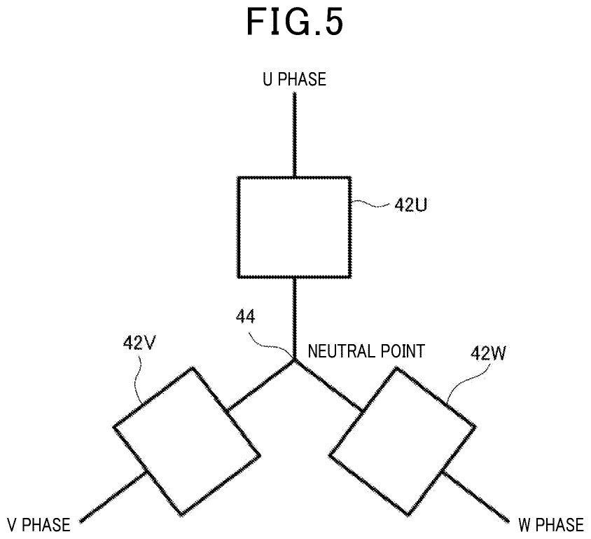

As shown in FIG. 4, the band member 34 is formed in a rectangular shape whose lateral direction coincides with the axial direction and whose longitudinal direction coincides with a direction perpendicular to the axial direction. The thickness of the band member 34 is set to such a thickness as to allow the band member 34 to be bent in the circumferential direction. In the present embodiment, the band member 34 is rolled along the circumferential direction a plurality of times into a cylindrical shape. In addition, in the present embodiment, most of the band member 34 has four layers in the radial direction.

As shown in FIG. 3, the coils 16 are formed on the band member 34. Moreover, as shown in FIGS. 3 and 4, the band member 34 is rolled along the circumferential direction a plurality of times so that the coils 16 are located at predetermined positions in the circumferential direction and the radial direction.

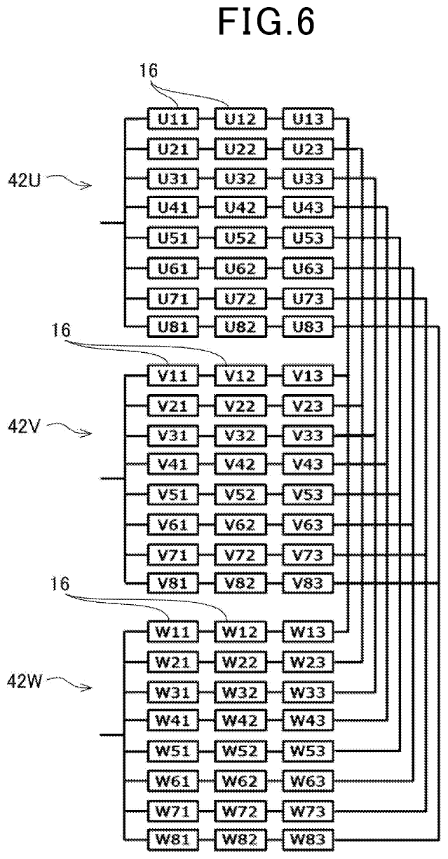

In the present embodiment, as shown in FIG. 5, those coils 16 which together constitute a U phase (or U-phase coil group 42U), those coils 16 which together constitute a V phase (or V-phase coil group 42V) and those coils 16 which together constitute a W phase (or W-phase coil group 42W) are star-connected. Specifically, as shown in FIG. 6, twenty-four coils 16 constituting the U-phase coil group 42U, twenty-four coils 16 constituting the V-phase coil group 42V and twenty-four coils 16 constituting the W-phase coil group 42W are star-connected.

Hereinafter, the twenty-four coils 16 constituting the U-phase coil group 42U will be designated respectively by reference signs U11, U12, U13, U21, U22, U23, U31, U32, U33, U41, U42, U43, U51, U52, U53, U61, U62, U63, U71, U72, U73, U81, U82 and U83.

Moreover, the twenty-four coils 16 constituting the V-phase coil group 42V will be designated respectively by reference signs V11, V12, V13, V21, V22, V23, V31, V32, V33, V41, V42, V43, V51, V52, V53, V61, V62, V63, V71, V72, V73, V81, V82 and V83.

Furthermore, the twenty-four coils 16 constituting the W-phase coil group 42W will be designated respectively by reference signs W11, W12, W13, W21, W22, W23, W31, W32, W33, W41, W42, W43, W51, W52, W53, W61, W62, W63, W71, W72, W73, W81, W82 and W83.

It should be noted that in the following explanation, specific coils 16 will be represented only by the reference signs depending on the situation.

The U-phase coils U11, U12 and U13 are connected in series with each other. The U-phase coils U21, U22 and U23 are connected in series with each other. The U-phase coils U31, U32 and U33 are connected in series with each other. The U-phase coils U41, U42 and U43 are connected in series with each other. The U-phase coils U51, U52 and U53 are connected in series with each other. The U-phase coils U61, U62 and U63 are connected in series with each other. The U-phase coils U71, U72 and U73 are connected in series with each other. The U-phase coils U81, U82 and U83 are connected in series with each other.

Moreover, an end of the U-phase coil U11 on a side not connected to the U-phase coil U12, an end of the U-phase coil U21 on a side not connected to the U-phase coil U22, an end of the U-phase coil U31 on a side not connected to the U-phase coil U32, an end of the U-phase coil U41 on a side not connected to the U-phase coil U42, an end of the U-phase coil U51 on a side not connected to the U-phase coil U52, an end of the U-phase coil U61 on a side not connected to the U-phase coil U62, an end of the U-phase coil U71 on a side not connected to the U-phase coil U72 and an end of the U-phase coil U81 on a side not connected to the U-phase coil U82 are connected with each other.

The V-phase coils V11, V12 and V13 are connected in series with each other. The V-phase coils V21, V22 and V23 are connected in series with each other. The V-phase coils V31, V32 and V33 are connected in series with each other. The V-phase coils V41, V42 and V43 are connected in series with each other. The V-phase coils V51, V52 and V53 are connected in series with each other. The V-phase coils V61, V62 and V63 are connected in series with each other. The V-phase coils V71, V72 and V73 are connected in series with each other. The V-phase coils V81, V82 and V83 are connected in series with each other.

Moreover, an end of the V-phase coil V11 on a side not connected to the V-phase coil V12, an end of the V-phase coil V21 on a side not connected to the V-phase coil V22, an end of the V-phase coil V31 on a side not connected to the V-phase coil V32, an end of the V-phase coil V41 on a side not connected to the V-phase coil V42, an end of the V-phase coil V51 on a side not connected to the V-phase coil V52, an end of the V-phase coil V61 on a side not connected to the V-phase coil V62, an end of the V-phase coil V71 on a side not connected to the V-phase coil V72 and an end of the V-phase coil V81 on a side not connected to the V-phase coil V82 are connected with each other.

The W-phase coils W11, W12 and W13 are connected in series with each other. The W-phase coils W21, W22 and W23 are connected in series with each other. The W-phase coils W31, W32 and W33 are connected in series with each other. The W-phase coils W41, W42 and W43 are connected in series with each other. The W-phase coils W51, W52 and W53 are connected in series with each other. The W-phase coils W61, W62 and W63 are connected in series with each other. The W-phase coils W71, W72 and W73 are connected in series with each other. The W-phase coils W81, W82 and W83 are connected in series with each other.

Moreover, an end of the W-phase coil W11 on a side not connected to the W-phase coil W12, an end of the W-phase coil W21 on a side not connected to the W-phase coil W22, an end of the W-phase coil W31 on a side not connected to the W-phase coil W32, an end of the W-phase coil W41 on a side not connected to the W-phase coil W42, an end of the W-phase coil W51 on a side not connected to the W-phase coil W52, an end of the W-phase coil W61 on a side not connected to the W-phase coil W62, an end of the W-phase coil W71 on a side not connected to the W-phase coil W72 and an end of the W-phase coil W81 on a side not connected to the W-phase coil W82 are connected with each other.

An end of the U-phase coil U13 on a side not connected to the U-phase coil U12, an end of the V-phase coil V13 on a side not connected to the V-phase coil V12 and an end of the W-phase coil W13 on a side not connected to the W-phase coil W12 are connected with each other.

An end of the U-phase coil U23 on a side not connected to the U-phase coil U22, an end of the V-phase coil V23 on a side not connected to the V-phase coil V22 and an end of the W-phase coil W23 on a side not connected to the W-phase coil W22 are connected with each other.

An end of the U-phase coil U33 on a side not connected to the U-phase coil U32, an end of the V-phase coil V33 on a side not connected to the V-phase coil V32 and an end of the W-phase coil W33 on a side not connected to the W-phase coil W32 are connected with each other.

An end of the U-phase coil U43 on a side not connected to the U-phase coil U42, an end of the V-phase coil V43 on a side not connected to the V-phase coil V42 and an end of the W-phase coil W43 on a side not connected to the W-phase coil W42 are connected with each other.

An end of the U-phase coil U53 on a side not connected to the U-phase coil U52, an end of the V-phase coil V53 on a side not connected to the V-phase coil V52 and an end of the W-phase coil W53 on a side not connected to the W-phase coil W52 are connected with each other.

An end of the U-phase coil U63 on a side not connected to the U-phase coil U62, an end of the V-phase coil V63 on a side not connected to the V-phase coil V62 and an end of the W-phase coil W63 on a side not connected to the W-phase coil W62 are connected with each other.

An end of the U-phase coil U73 on a side not connected to the U-phase coil U72, an end of the V-phase coil V73 on a side not connected to the V-phase coil V72 and an end of the W-phase coil W73 on a side not connected to the W-phase coil W72 are connected with each other.

An end of the U-phase coil U83 on a side not connected to the U-phase coil U82, an end of the V-phase coil V83 on a side not connected to the V-phase coil V82 and an end of the W-phase coil W83 on a side not connected to the W-phase coil W82 are connected with each other.

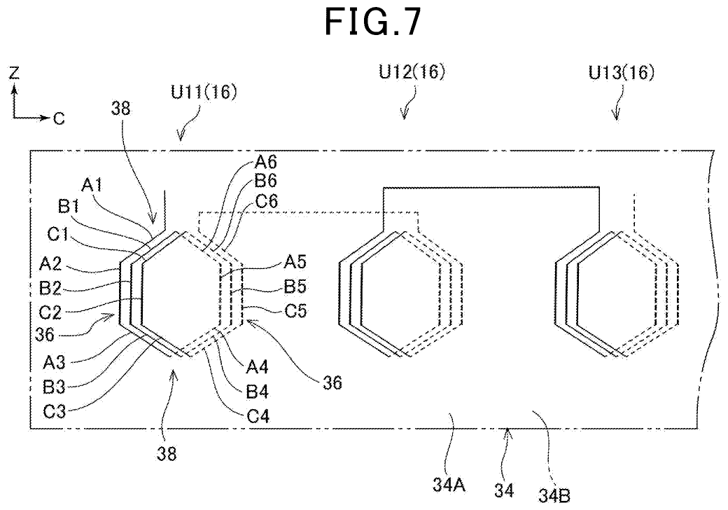

FIG. 7 schematically shows some of the U-phase coils 16. In the present embodiment, each of the coils 16 is formed to have a hexagonal shape when viewed in the thickness direction of the band member 34. Moreover, each of the coils 16 has the same configuration as a three-turn coil in which a conductor wire is wound three turns.

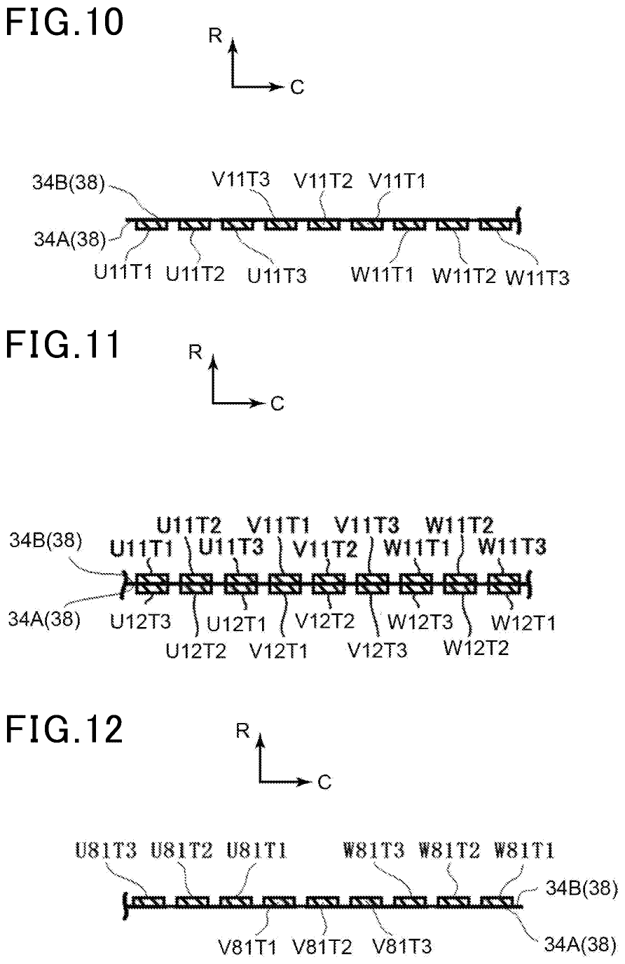

That part of the U-phase coil U11 which constitutes the first turn includes: a first straight portion A1 that is inclined toward the second side in the circumferential direction as it extends to the second side in the axial direction; a second straight portion A2 that extends from the first straight portion A1 to the second side in the axial direction; and a third straight portion A3 that is inclined toward the first side in the circumferential direction as it extends from the second straight portion A2 to the second side in the axial direction. Moreover, that part of the U-phase coil U11 which constitutes the first turn also includes: a fourth straight portion A4 that is inclined toward the first side in the circumferential direction as it extends from the third straight portion A3 to the first side in the axial direction; a fifth straight portion A5 that extends from the fourth straight portion A4 to the first side in the axial direction; and a sixth straight portion A6 that is inclined toward the second side in the circumferential direction as it extends from the fifth straight portion A5 to the first side in the axial direction. Furthermore, the first straight portion A1, the second straight portion A2 and the third straight portion A3 are formed on a first surface 34A (see FIG. 10) of the band member 34. On the other hand, the fourth straight portion A4, the fifth straight portion A5 and the sixth straight portion A6 are formed on a second surface 34B (see FIG. 10) of the band member 34. In addition, the third straight portion A3 and the fourth straight portion A4 are electrically connected via a through-hole (not shown) that penetrates the band member 34. It should be noted that in FIG. 7, those portions of the U-phase coil U11 which are formed on the first surface 34A of the band member 34 are shown by solid lines, whereas those portions of the U-phase coil U11 which are formed on the second surface 34B of the band member 34 are shown by dashed lines.

That part of the U-phase coil U11 which constitutes the second turn includes: a first straight portion B1 that is inclined toward the second side in the circumferential direction as it extends from the sixth straight portion A6 of the first turn to the second side in the axial direction; a second straight portion B2 that extends from the first straight portion B1 to the second side in the axial direction; and a third straight portion B3 that is inclined toward the first side in the circumferential direction as it extends from the second straight portion B2 to the second side in the axial direction. Moreover, that part of the U-phase coil U11 which constitutes the second turn also includes: a fourth straight portion B4 that is inclined toward the first side in the circumferential direction as it extends from the third straight portion B3 to the first side in the axial direction; a fifth straight portion B5 that extends from the fourth straight portion B4 to the first side in the axial direction; and a sixth straight portion B6 that is inclined toward the second side in the circumferential direction as it extends from the fifth straight portion B5 to the first side in the axial direction. Furthermore, the sixth straight portion A6 and the first straight portion B1 are electrically connected via a through-hole (not shown) that penetrates the band member 34. Similarly, the third straight portion B3 and the fourth straight portion B4 are electrically connected via a through-hole (not shown) that penetrates the band member 34.

That part of the U-phase coil U11 which constitutes the third turn includes: a first straight portion C1 that is inclined toward the second side in the circumferential direction as it extends from the sixth straight portion B6 of the second turn to the second side in the axial direction; a second straight portion C2 that extends from the first straight portion C1 to the second side in the axial direction; and a third straight portion C3 that is inclined toward the first side in the circumferential direction as it extends from the second straight portion C2 to the second side in the axial direction. Moreover, that part of the U-phase coil U11 which constitutes the third turn also includes: a fourth straight portion C4 that is inclined toward the first side in the circumferential direction as it extends from the third straight portion C3 to the first side in the axial direction; a fifth straight portion C5 that extends from the fourth straight portion C4 to the first side in the axial direction; and a sixth straight portion C6 that is inclined toward the second side in the circumferential direction as it extends from the fifth straight portion C5 to the first side in the axial direction. Furthermore, the sixth straight portion B6 and the first straight portion C1 are electrically connected via a through-hole (not shown) that penetrates the band member 34. Similarly, the third straight portion C3 and the fourth straight portion C4 are electrically connected via a through-hole (not shown) that penetrates the band member 34.

That part (i.e., the first straight portion B1 to the sixth straight portion B6) of the U-phase coil U11 which constitutes the second turn is offset to the first side in the circumferential direction from that part (i.e., the first straight portion A1 to the sixth straight portion A6) of the U-phase coil U11 which constitutes the first turn. Further, that part (i.e., the first straight portion C1 to the sixth straight portion C6) of the U-phase coil U11 which constitutes the third turn is offset to the first side in the circumferential direction from that part (i.e., the first straight portion B1 to the sixth straight portion B6) of the U-phase coil U11 which constitutes the second turn.

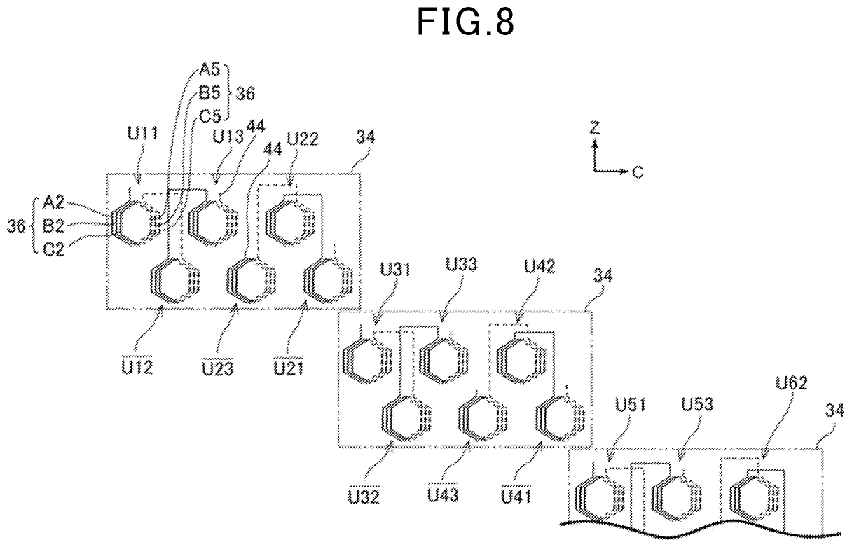

Moreover, as shown in FIGS. 7 and 8, the other U-phase coils (U12, . . . , U8 3) are also configured in the same manner as the U-phase coil U11. That is, all the U-phase coils (U11, . . . , U83) have the same configuration. It should be noted that the second straight portions A2, B2 and C2 and the fifth straight portions A5, B5 and C5 described above may be referred to as vertical portions 36. It also should be noted that: the first straight portions A1, B1 and C1 and the sixth straight portions A6, B6 and C6 may be referred to as first coil end portions 38; and the third straight portions A3, B3 and C3 and the fourth straight portions A4, B4 and C4 may be referred to as second coil end portions 38.

FIG. 8 is a schematic diagram showing U-phase coil subgroups offset from each other in the axial direction. One of the U-phase coil subgroups includes the U-phase coil U11; and another one of the U-phase coil subgroups includes the U-phase coil U12.

As shown in FIG. 8 and FIG. 7, the fifth straight portion A5, the fifth straight portion B5 and the fifth straight portion C5 of the U-phase coil U11 are located respectively at the same circumferential positions as the second straight portion A2, the second straight portion B2 and the second straight portion C2 of the U-phase coil U12. That is, the fifth straight portion A5, the fifth straight portion B5 and the fifth straight portion C5 of the U-phase coil U11 respectively overlap the second straight portion A2, the second straight portion B2 and the second straight portion C2 of the U-phase coil U12 via the band member 34.

Moreover, the fifth straight portion A5, the fifth straight portion B5 and the fifth straight portion C5 of the U-phase coil U12 are located respectively at the same circumferential positions as the second straight portion A2, the second straight portion B2 and the second straight portion C2 of the U-phase coil U13. That is, the fifth straight portion A5, the fifth straight portion B5 and the fifth straight portion C5 of the U-phase coil U12 respectively overlap the second straight portion A2, the second straight portion B2 and the second straight portion C2 of the U-phase coil U13 via the band member 34.

Furthermore, the fifth straight portion A5, the fifth straight portion B5 and the fifth straight portion C5 of the U-phase coil U13 are located respectively at the same circumferential positions as the second straight portion A2, the second straight portion B2 and the second straight portion C2 of the U-phase coil U23. That is, the fifth straight portion A5, the fifth straight portion B5 and the fifth straight portion C5 of the U-phase coil U13 respectively overlap the second straight portion A2, the second straight portion B2 and the second straight portion C2 of the U-phase coil U23 via the band member 34.

Furthermore, the fifth straight portion A5, the fifth straight portion B5 and the fifth straight portion C5 of the U-phase coil U23 are located respectively at the same circumferential positions as the second straight portion A2, the second straight portion B2 and the second straight portion C2 of the U-phase coil U22. That is, the fifth straight portion A5, the fifth straight portion B5 and the fifth straight portion C5 of the U-phase coil U23 respectively overlap the second straight portion A2, the second straight portion B2 and the second straight portion C2 of the U-phase coil U22 via the band member 34.

Furthermore, the fifth straight portion A5, the fifth straight portion B5 and the fifth straight portion C5 of the U-phase coil U22 are located respectively at the same circumferential positions as the second straight portion A2, the second straight portion B2 and the second straight portion C2 of the U-phase coil U21. That is, the fifth straight portion A5, the fifth straight portion B5 and the fifth straight portion C5 of the U-phase coil U22 respectively overlap the second straight portion A2, the second straight portion B2 and the second straight portion C2 of the U-phase coil U21 via the band member 34.

The U-phase coils U11, U12, U13, U23, U22 and U21 described above are arranged in this order on the first lap of the rolled band member 34. That is, the U-phase coils U11, U12, U13, U23, U22 and U21 are arranged in this order on the closest layer of the rolled band member 34 to the rotor 12.

Moreover, the sixth straight portion C6 of the U-phase coil U11 and the sixth straight portion C6 of the U-phase coil U12 are connected with each other. The first straight portion A1 of the U-phase coil U12 and the first straight portion A1 of the U-phase coil U13 are connected with each other. The sixth straight portion C6 of the U-phase coil U23 and the sixth straight portion C6 of the U-phase coil U22 are connected with each other. The first straight portion A1 of the U-phase coil U22 and the first straight portion A1 of the U-phase coil U21 are connected with each other. Consequently, in the present embodiment, although the U-phase coils U11, U12, U13, U23, U22 and U21 are physically configured as coils wound in one direction (or as left-handed coils to be described later), the U-phase coils U12, U23 and U21 will function identically to coils wound in the opposite direction to the U-phase coils U11, U13 and U22 (or identically to right-handed coils) when the U-phase coils U11, U12, U13, U23, U22 and U21 are energized. Hereinafter, for the sake of convenience of explanation, coils corresponding to the U-phase coils U11, U13 and U22 will be referred to as the “left-handed coils”; and coils corresponding to the U-phase coils U12, U23 and U21 will be referred to as the “right-handed coils”. In addition, in FIG. 8, lines (or bars) are attached to the reference signs U12, U23 and U21 designating the right-handed coils. Moreover, in the present embodiment, the left-handed coils and the right-handed coils are arranged alternately in the circumferential direction.

Similarly, the fifth straight portion A5, the fifth straight portion B5 and the fifth straight portion C5 of the U-phase coil U31 are located respectively at the same circumferential positions as the second straight portion A2, the second straight portion B2 and the second straight portion C2 of the U-phase coil U32. That is, the fifth straight portion A5, the fifth straight portion B5 and the fifth straight portion C5 of the U-phase coil U31 respectively overlap the second straight portion A2, the second straight portion B2 and the second straight portion C2 of the U-phase coil U32 via the band member 34.

Moreover, the fifth straight portion A5, the fifth straight portion B5 and the fifth straight portion C5 of the U-phase coil U32 are located respectively at the same circumferential positions as the second straight portion A2, the second straight portion B2 and the second straight portion C2 of the U-phase coil U33. That is, the fifth straight portion A5, the fifth straight portion B5 and the fifth straight portion C5 of the U-phase coil U32 respectively overlap the second straight portion A2, the second straight portion B2 and the second straight portion C2 of the U-phase coil U33 via the band member 34.

Furthermore, the fifth straight portion A5, the fifth straight portion B5 and the fifth straight portion C5 of the U-phase coil U33 are located respectively at the same circumferential positions as the second straight portion A2, the second straight portion B2 and the second straight portion C2 of the U-phase coil U43. That is, the fifth straight portion A5, the fifth straight portion B5 and the fifth straight portion C5 of the U-phase coil U33 respectively overlap the second straight portion A2, the second straight portion B2 and the second straight portion C2 of the U-phase coil U43 via the band member 34.

Furthermore, the fifth straight portion A5, the fifth straight portion B5 and the fifth straight portion C5 of the U-phase coil U43 are located respectively at the same circumferential positions as the second straight portion A2, the second straight portion B2 and the second straight portion C2 of the U-phase coil U42. That is, the fifth straight portion A5, the fifth straight portion B5 and the fifth straight portion C5 of the U-phase coil U43 respectively overlap the second straight portion A2, the second straight portion B2 and the second straight portion C2 of the U-phase coil U42 via the band member 34.

Furthermore, the fifth straight portion A5, the fifth straight portion B5 and the fifth straight portion C5 of the U-phase coil U42 are located respectively at the same circumferential positions as the second straight portion A2, the second straight portion B2 and the second straight portion C2 of the U-phase coil U41. That is, the fifth straight portion A5, the fifth straight portion B5 and the fifth straight portion C5 of the U-phase coil U42 respectively overlap the second straight portion A2, the second straight portion B2 and the second straight portion C2 of the U-phase coil U41 via the band member 34.

In addition, the U-phase coils U31, U32, U33, U43, U42 and U41 described above are arranged in this order on the second lap of the rolled band member 34. Moreover, the fifth straight portion A5, the fifth straight portion B5 and the fifth straight portion C5 of the U-phase coil U21 arranged on the first lap of the rolled band member 34 are located respectively at the same circumferential positions as the second straight portion A2, the second straight portion B2 and the second straight portion C2 of the U-phase coil U31 arranged on the second lap of the rolled band member 34.

Furthermore, the U-phase coils U31, U32, U33, U43, U42 and U41 arranged on the second lap of the band member 34 are connected in the same manner as the U-phase coils U11, U12, U13, U23, U22 and U21 arranged on the first lap of the band member 34.

The U-phase coils U51 to U83 are also arranged on the band member 34 in the same manner as the U-phase coils U11 to U43 described above. Consequently, the U-phase coils U51, U52, U53, U63, U62 and U61 are arranged in this order on the third lap of the rolled band member 34; and the U-phase coils U71, U72, U73, U83, U82 and U81 are arranged in this order on the fourth lap of the rolled band member 34.

Moreover, the U-phase coils U51, U52, U53, U63, U62 and U61 arranged on the third lap of the band member 34 are connected in the same manner as the U-phase coils U11, U12, U13, U23, U22 and U21 arranged on the first lap of the band member 34. Furthermore, the U-phase coils U71, U72, U73, U83, U82 and U81 arranged on the fourth lap of the band member 34 are also connected in the same manner as the U-phase coils U11, U12, U13, U23, U22 and U21 arranged on the first lap of the band member 34.

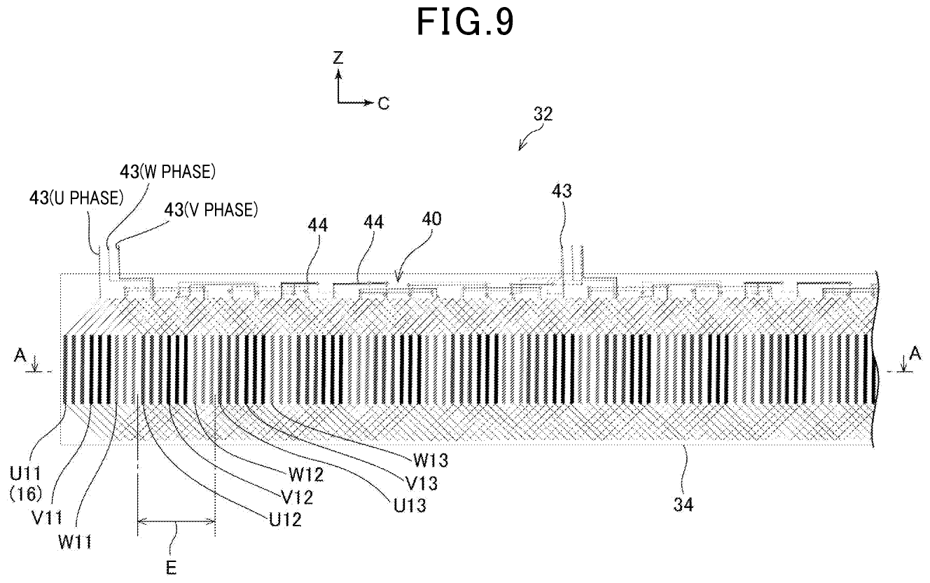

As shown in FIGS. 8 and 9, the V-phase coils V11 to V83 are also arranged on the band member 34 in the same manner as the U-phase coils U11 to U83. Moreover, the W-phase coils W11 to W83 are also arranged on the band member 34 in the same manner as the U-phase coils U11 to U83. However, the V-phase coils V11 to V83 are connected so that the winding direction of the V-phase coils is opposite to those of the U-phase coils and the W-phase coils.

Moreover, the V-phase coils V11 to V83 are offset to the first side in the circumferential direction with respect to the U-phase coils U11 to U83. Further, the W-phase coils W11 to W83 are offset to the first side in the circumferential direction with respect to the V-phase coils V11 to V83.

FIG. 10 shows a part of a cross section of the band member 34 and the coils 16 taken along the line A-A in FIG. 9. It should be noted that the part of the cross section shown in FIG. 10 includes the cross section of an end part of the band member 34 on the second side in the circumferential direction. As shown in FIG. 10, in this part of the cross section, U11T1, U11T2, U11T3, V11T3, V11T2, V11T1, W11T1, W11T2 and W11T3 are formed in this order on the first surface 34A of the band member 34.

Here, reference signs T1, T2 and T3, which respectively indicate the first, second and third turns of the coils, are suffixed to the reference signs respectively designating the coils. For example, the first turn of the U-phase coil U11 is designated by the reference sign U11T1; the second turn of the U-phase coil U11 is designated by the reference sign U11T2; and the third turn of the U-phase coil U11 is designated by the reference sign U11T3.

FIG. 11 shows another part of the cross section of the band member 34 and the coils 16 taken along the line A-A in FIG. 9. It should be noted that the part of the cross section shown in FIG. 11 is that part of the cross section which is indicted by the arrow E in FIG. 9. It also should be noted that the part of the cross section shown in FIG. 11 is adjacent to the part of the cross section shown in FIG. 10 in the circumferential direction. In the part of the cross section shown in FIG. 11, U12T3, U12T2, U12T1, V12T1, V12T2, V12T3, W12T3, W12T2 and W12T1 are formed in this order on the first surface 34A of the band member 34. Moreover, in the part of the cross section shown in FIG. 11, U11T1, U11T2, U11T3, V11T3, V11T2, V11T1, W11T1, W11T2 and W11T3 are formed in this order on the second surface 34B of the band member 34.

Moreover, although not shown in the drawings, on the first side of the part of the cross section shown in FIG. 11 in the circumferential direction, the first, second and third turns of the U-phase coils (U12, U13, U23, . . . , U83, U82, U81), the V-phase coils (V12, V13, V23, . . . , V83, V82, V81) and the W-phase coils (W12, W13, W23, . . . , W83, W82, W81) are formed on the first surface 34A and the second surface 34B of the band member 34 in the same manner as shown in FIG. 11.

FIG. 12 shows yet another part of the cross section of the band member 34 and the coils 16 taken along the line A-A in FIG. 9. It should be noted that the part of the cross section shown in FIG. 12 includes the cross section of an end part of the band member 34 on the first side in the circumferential direction. As shown in FIG. 12, in this part of the cross section, U81T1, U81T2, U81T3, V81T3, V81T2, V81T1, W81T1, W81T2 and W81T3 are formed in this order on the second surface 34B of the band member 34.

Moreover, as shown in FIG. 9, the coils 16 are connected via a connection pattern section 40 provided on a part of the band member 34 on the first side in the axial direction. It should be noted that in FIG. 9, those portions of the connection pattern section 40 which are formed on the first surface 34A of the band member 34 are shown by solid lines, whereas those portions of the connection pattern section 40 which are formed on the second surface 34B of the band member 34 are shown by dashed lines. It also should be noted that in FIG. 9, those portions of the connection pattern section 40 which are designated by the reference numeral 44 represent the neutral point; and those portions of the connection pattern section 40 which are designated by the reference numeral 43 represent connection portions that are connected to a control unit (not shown). In addition, the connection between the coils 16 and the connection of the connection portions (40, 43, 44) to the control unit may be made alternatively by connection members formed separately from the band member 34, such as busbars or a printed circuit board.

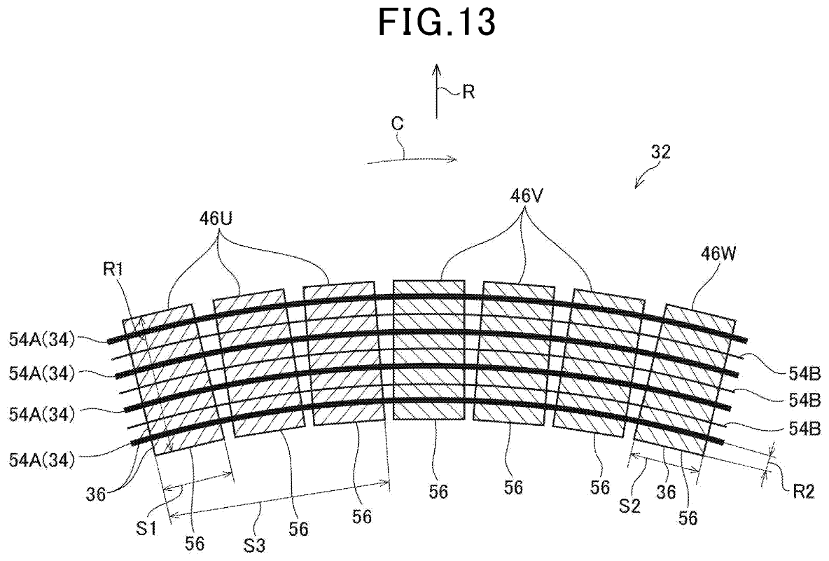

As described above, the band member 34 is rolled along the circumferential direction a plurality of times so that the coils 16 are located at predetermined positions in the circumferential direction and the radial direction. FIG. 13 shows a part of a cross section of the coil assembly 32 taken along the radial direction, where the band member 34 is in the rolled state. It should be noted that this cross section of the coil assembly 32 is a cross section corresponding to the vertical portion 36 (see FIG. 7) of the coils 16.

In the cross section shown in FIG. 13, the vertical portions 36 of the coils 16 are laminated in the radial direction and arranged at equal intervals in the circumferential direction. Moreover, in the state where the vertical portions 36 of the coils 16 are laminated in the radial direction, a first insulating layer 54A or a second insulating layer 54B is interposed between each radially-adjacent pair of the vertical portions 36. The first insulating layer 54A is constituted of the band member 34. On the other hand, the second insulating layer 54B is constituted of an insulating film that is formed to cover the coils 16 formed on the band member 34. The insulating film may be formed of, for example, an electrically-insulative paint. Hereinafter, the laminates in each of which the vertical portions 36 of the coils 16 are laminated in the radial direction will be referred to as the vertical-portion laminates 56. Each of the vertical-portion laminates 56 has a rectangular cross section along the radial direction; in the rectangular cross section, the radial dimension R1 is greater than the circumferential dimension S1. Moreover, in the present embodiment, for each of the vertical portions 36 constituting the vertical-portion laminates 56, the circumferential dimension S2 of the vertical portion 36 is set to be greater than the radial dimension R2 of the vertical portion 36.

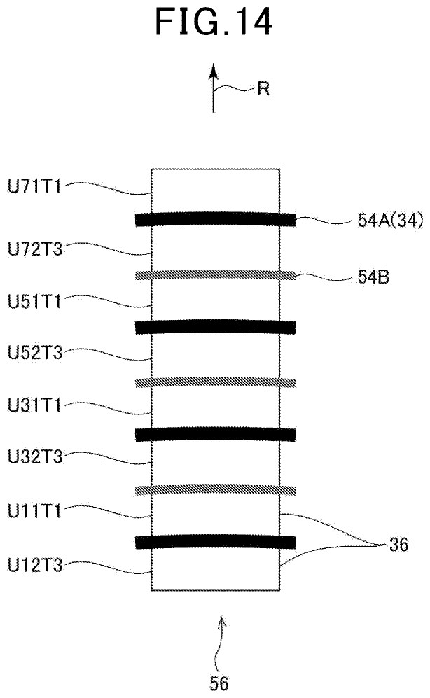

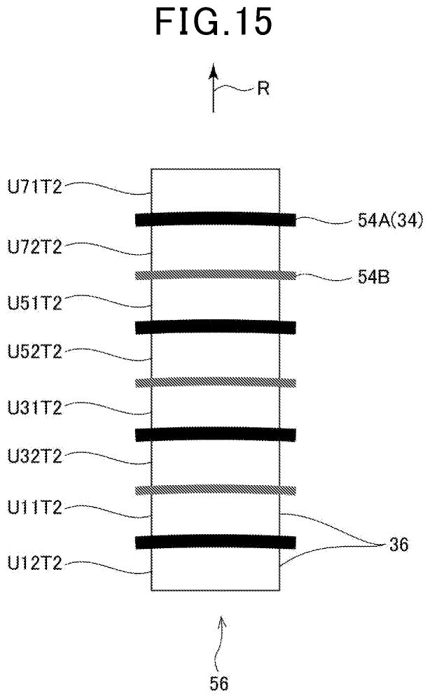

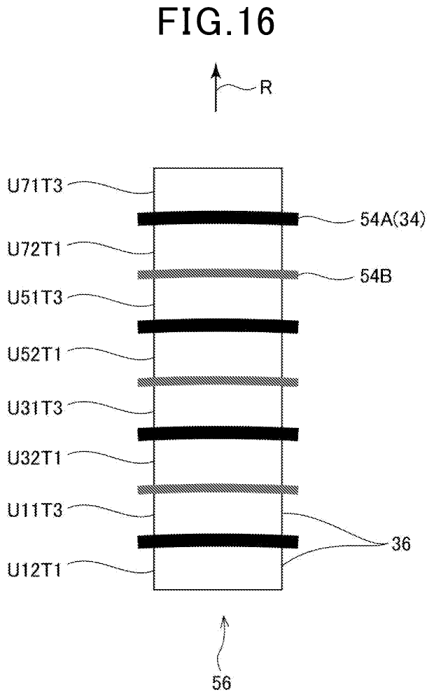

FIG. 14, FIG. 15 and FIG. 16 respectively show a vertical-portion laminate 56 in which U12T3 is located at the radially inner end, a vertical-portion laminate 56 in which U12T2 is located at the radially inner end, and a vertical-portion laminate 56 in which U12T1 is located at the radially inner end.

As shown in FIG. 14, in the vertical-portion laminate 56 in which U12T3 is located at the radially inner end, the vertical portions 36 of U12T3, U11T1, U32T3, U31T1, U52T3, U51T1, U72T3 and U71T1 are sequentially arranged in alignment with each other from the radially inner side to the radially outer side.

As shown in FIG. 15, in the vertical-portion laminate 56 in which U12T2 is located at the radially inner end, the vertical portions 36 of U12T2, U11T2, U32T2, U31T2, U52T2, U51T2, U72T2 and U71T2 are sequentially arranged in alignment with each other from the radially inner side to the radially outer side.

As shown in FIG. 16, in the vertical-portion laminate 56 in which U12T1 is located at the radially inner end, the vertical portions 36 of U12T1, U11T3, U32T1, U31T3, U52T1, U51T3, U72T1 and U71T3 are sequentially arranged in alignment with each other from the radially inner side to the radially outer side.

As shown in FIG. 13 (see also FIGS. 14 to 16), the vertical-portion laminate 56 in which U12T3 is located at the radially inner end, the vertical-portion laminate 56 in which U12T2 is located at the radially inner end, and the vertical-portion laminate 56 in which U12T1 is located at the radially inner end are arranged in this order in the circumferential direction to together constitute a U-phase conductor group 46U. In the present embodiment, the circumferential dimension S3 of the U-phase conductor group 46U at the radially inner end thereof is set to be greater than the radial dimension R1 of each of the vertical-portion laminates 56 constituting the U-phase conductor group 46U.

The vertical portions 36 of the other coils 16 are also laminated to form vertical-portion laminates 56 in the same manner as described above. Moreover, a V-phase conductor group 46V and a W-phase conductor group 46W are also formed in the same manner as the above-described U-phase conductor group 46U. In addition, the U-phase conductor group 46U, the V-phase conductor group 46V and the W-phase conductor group 46W are arranged in this order in the circumferential direction.

### (Operation and Effects of Motor According to Present Embodiment)

Next, operation and effects of the motor 10 according to the present embodiment will be described.

As shown in FIGS. 1, 2, 5 and 9, in the motor 10 according to the present embodiment, a rotating magnetic field is generated on the inner periphery of the stator 14 by switching of the energization of the U-phase coil group 42U, the V-phase coil group 42V and the W-phase coil group 42W that constitute part of the stator 14. Consequently, the rotor 12 is caused by the rotating magnetic field to rotate.

In the present embodiment, the coil assembly 32 includes the band member 34 formed of an electrically-insulative material in a band shape, and the coils 16 formed on the band member 34. Moreover, the band member 34 is rolled along the circumferential direction a plurality of times so that the coils 16 are located at predetermined positions in the circumferential direction and the radial direction. With this configuration, it becomes possible to suppress increase in the size of the coil assembly 32 in the radial direction. As a result, it becomes possible to suppress increase in the size of the motor 10.

Moreover, as shown in FIG. 13, in the present embodiment, for each of the conductor groups 46U, 46V and 46W of the respective phases, the circumferential dimension S3 of the conductor group at the radially inner end thereof (i.e., at the end thereof on the side of the magnets 18 of the rotor 12) is set to be greater than the radial dimension R1 of each of the vertical-portion laminates 56 constituting the conductor group. With the above setting, it becomes possible to reduce the radial thickness of the coil assembly 32 and thus the gap between the magnets 18 of the rotor 12 and the stator core 26. Accordingly, it becomes possible to reduce the magnetic reluctance. Consequently, it becomes possible to further improve the torque of the motor 10.

Furthermore, in the present embodiment, for each of the vertical-portion laminates 56, the radial dimension R1 of the vertical-portion laminate 56 is set to be greater than the circumferential dimension S1 of the vertical-portion laminate 56. Consequently, it becomes possible to reduce the area of each of the vertical-portion laminates 56 facing the magnets 18 of the rotor 12 while securing the cross-sectional area of each of the vertical-portion laminates 56. Thus, it becomes possible to suppress eddy current generated in the vertical-portion laminates 56 due to radial magnetic flux. As a result, it becomes possible to further improve the torque of the motor 10.

Furthermore, in the present embodiment, for each of the vertical portions 36 constituting the vertical-portion laminates 56, the circumferential dimension S2 of the vertical portion 36 is set to be greater than the radial dimension R2 of the vertical portion 36. Consequently, it becomes possible to suppress eddy current generated in the vertical-portion laminates 56 due to leakage magnetic flux between the magnets 18 of the rotor 12. As a result, it becomes possible to further improve the torque of the motor 10.

Furthermore, in the present embodiment, the U-phase coils 16 are arranged in alignment with one another in the circumferential direction and all physically wound in one direction. Moreover, the U-phase coils 16 are connected so that when the U-phase coils 16 are energized, the U-phase coils 16 function identically to left-handed U-phase coils and right-handed U-phase coils which are arranged alternately in the circumferential direction. In addition, the V-phase coils 16 and the W-phase coils 16 are also configured in the same manner as the U-phase coils 16. Consequently, in the present embodiment, as shown in FIG. 14, it becomes possible to reduce the electric potential differences between the radially-laminated vertical portions 36 of the coils 16 in the vertical-portion laminates 56. Specifically, even though the vertical portions 36 having different turn numbers (T1 to T3) are arranged adjacent to each other in the radial direction, it still becomes possible to reduce the electric potential differences between the radially-laminated vertical portions 36, such as the electric potential difference between U12T3 and U11T1. Consequently, it becomes possible to improve the reliability of electrical insulation between the radially-laminated vertical portions 36 of the coils 16 in the vertical-portion laminates 56. As a result, it becomes possible to reduce the thicknesses of the first and second insulating layers 54A and 54B.

### (Configuration for Having Coil Assembly 32 Supported by Stator Core 26)

Next, explanation will be given of a configuration for securing the positional accuracy of the coil assembly 32, which is applied to the motor 10 according to the present embodiment, with respect to the stator core 26 while having the coil assembly 32 supported by the stator core 26.

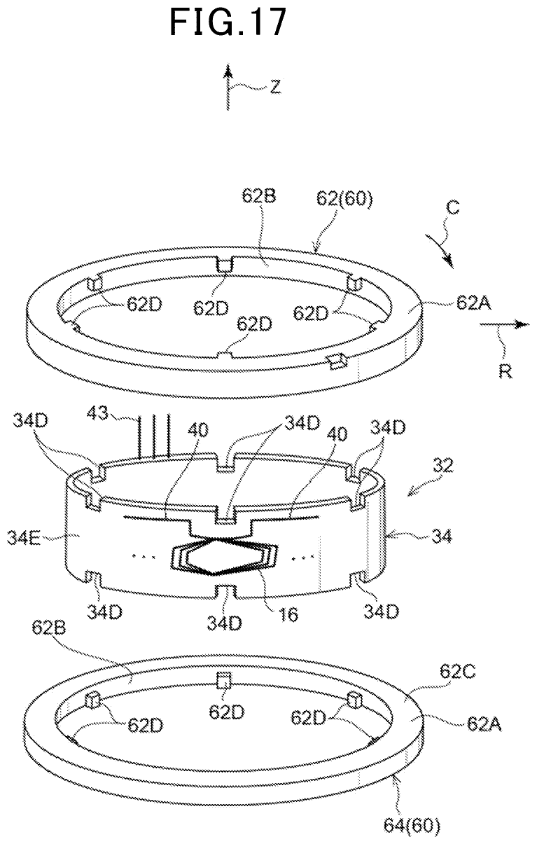

As shown in FIGS. 17 to 20, between the stator core 26 and the coil assembly 32, there is provided a coil assembly support member 60. The coil assembly 32 is supported by the stator core 26 via the coil assembly support member 60.

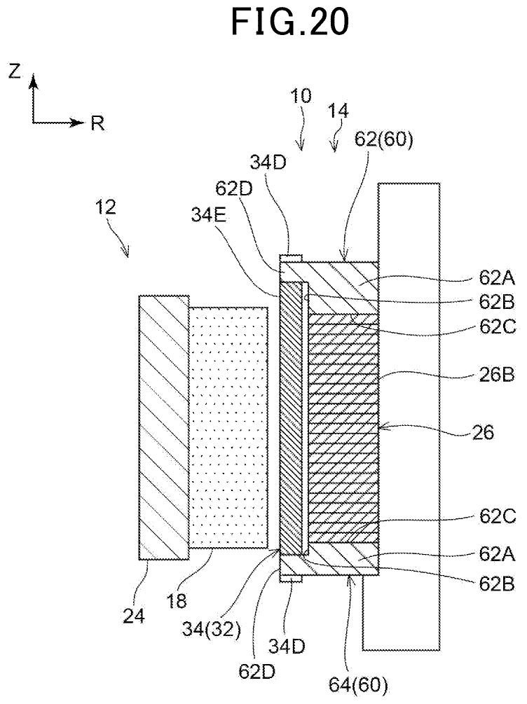

As shown in FIG. 17, the coil assembly support member 60 is composed of a first support member 62 mounted to an end face of the stator core 26 (see FIG. 20) on the first side in the axial direction and a second support member 64 mounted to an end face of the stator core 26 on the second side in the axial direction.

The first support member 62 is formed of an electrically-insulative material such as a resin material. The first support member 62 includes a support member main body 62A serving as an engagement member main body; the support member main body 62A is formed to have an annular shape when viewed in the axial direction. As shown in FIG. 20, the support member main body 62A has a rectangular cross section taken along the radial direction and the axial direction. Moreover, the radial thickness of the support member main body 62A is set to be equal to the radial thickness of the stator core 26. A radially inner surface of the support member main body 62A serves as a band member abutment surface 62B that abuts against an end portion of the band member 34 of the coil assembly 32 on the first side in the axial direction via the insulator 28 (not shown). On the other hand, a surface of the support member main body 62A on the second side in the axial direction serves as a core abutment surface 62C that abuts against the end face of the stator core 26 on the first side in the axial direction. The support member main body 62A is fixed to the stator core 26 by protrusion-recess fitting, bonding or the like.

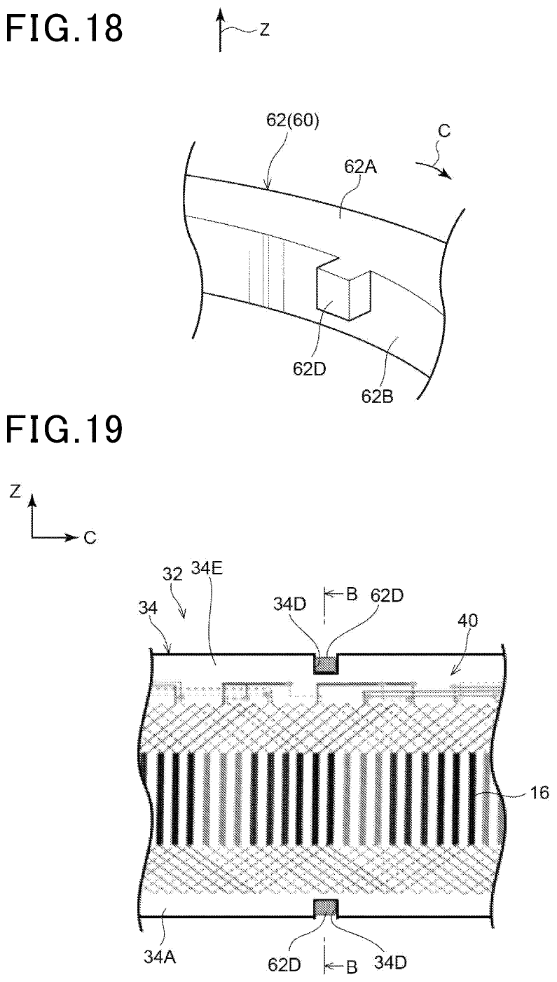

As shown in FIGS. 17 and 18, the first support member 62 also includes a plurality of support-member-side protrusions 62D serving as second engagement portions; the support-member-side protrusions 62D protrude radially inward from the radially inner surface of the support member main body 62A. More particularly, in the present embodiment, the first support member 62 has six support-member-side protrusions 62D arranged at equal intervals in the circumferential direction. Moreover, the six support-member-side protrusions 62D are formed in a rectangular parallelepiped shape. In addition, the six support-member-side protrusions 62D are located at positions offset from an axial center position of the support member main body 62A to the first side in the axial direction.

As shown in FIGS. 17 and 20, similar to the first support member 62, the second support member 64 is also formed of an electrically-insulative material such as a resin material. The second support member 64 has the same configuration as the first support member 62. Therefore, portions of the second support member 64 corresponding to those of the first support member 62 are designated by the same reference signs as the corresponding portions of the first support member 62.

A radially inner surface of a support member main body 62A of the second support member 64 serves as a band member abutment surface 62B that abuts against an end portion of the band member 34 of the coil assembly 32 on the second side in the axial direction via the insulator 28 (not shown). On the other hand, a surface of the support member main body 62A of the second support member 64 on the first side in the axial direction serves as a core abutment surface 62C that abuts against the end face of the stator core 26 on the second side in the axial direction. The support member main body 62A of the second support member 64 is also fixed to the stator core 26 by protrusion-recess fitting, bonding or the like. Moreover, the second support member 64 also has six support-member-side protrusions 62D located at positions offset from an axial center position of the support member main body 62A to the second side in the axial direction.

As shown in FIGS. 17 and 19, at the end of the band member 34 of the coil assembly 32 on the first side in the axial direction, there are formed six coil-assembly-side recesses 34D serving as first engagement portions with which the six support-member-side protrusions 62D of the first support member 62 respectively engage. Each of the coil-assembly-side recesses 34D is formed to have a rectangular shape when viewed from the radially inner side. Moreover, each of the coil-assembly-side recesses 34D has a peripheral edge formed in a U-shape that is open on the first side in the axial direction. Similarly, at the end of the band member 34 of the coil assembly 32 on the second side in the axial direction, there are formed six coil-assembly-side recesses 34D serving as first engagement portions with which the six support-member-side protrusions 62D of the second support member 64 respectively engage. Each of the coil-assembly-side recesses 34D is also formed to have a rectangular shape when viewed from the radially inner side. Moreover, each of the coil-assembly-side recesses 34D has a peripheral edge formed in a U-shape that is open on the second side in the axial direction. In addition, defining the annularly-rolled part of the band member 34 as a band member main body 34E, the coil-assembly-side recesses 34D may be described as being formed in the band member main body 34E.

As shown in FIGS. 19 and 20, the six support-member-side protrusions 62D of the first support member 62 are engaged respectively with the six coil-assembly-side recesses 34D formed at the end of the band member 34 of the coil assembly 32 on the first side in the axial direction. On the other hand, the six support-member-side protrusions 62D of the second support member 64 are engaged respectively with the six coil-assembly-side recesses 34D formed at the end of the band member 34 of the coil assembly 32 on the second side in the axial direction. Consequently, the coil assembly 32 is supported by the stator core 26 via the coil assembly support member 60 (i.e., the first support member 62 and the second support member 64). Moreover, by the coil assembly support member 60 (i.e., the first support member 62 and the second support member 64), the coil assembly 32 is positioned with respect to the stator core 26 in the circumferential, axial and radial directions. Hence, in the present embodiment, with the coil assembly support member 60 (i.e., the first support member 62 and the second support member 64), it becomes possible to secure the positional accuracy of the coil assembly 32 with respect to the stator core 26 simply by assembling the stator 14 in a predetermined procedure.

Moreover, with the coil assembly support member 60 (i.e., the first support member 62 and the second support member 64), it becomes possible to stably hold the coil assembly 32 for a long period of time against stresses such as torque generated in the coil assembly 32. Furthermore, with the coil assembly support member 60 (i.e., the first support member 62 and the second support member 64), it also becomes possible to prevent the coil assembly 32 from rotating freely relative to the stator core 26.

In the present embodiment, each of the coil-assembly-side recesses 34D is formed in the annularly-rolled band member main body 34E. Consequently, it becomes possible to have the coil assembly 32 supported by the stator core 26 via the coil assembly support member 60 (i.e., the first support member 62 and the second support member 64) without increasing the axial dimension of the band member 34. In addition, the axial dimension of the band member 34 can be further reduced by arranging each of the coil-assembly-side recesses 34D at a selected position that is between different portions of the connection pattern section 40 in the circumferential direction and overlaps any portion of the connection pattern section 40 in the axial direction (see FIG. 17).

It should be noted that the number, shape and dimensions of the coil-assembly-side recesses 34D and the number, shape and dimensions of the support-member-side protrusions 62D are not limited to those described above, but may be set properly in consideration of the size of the motor 10, the torque generated in the coil assembly 32, and the like.

### Second Embodiment

Next, a motor 66 according to the second embodiment will be described. It should be noted that: members and parts of the motor 66 according to the second embodiment corresponding to those of the motor 10 according to the first embodiment are designated by the same reference signs as the corresponding members and parts of the motor 10 according to the first embodiment; and description of these parts and members will be omitted hereinafter.

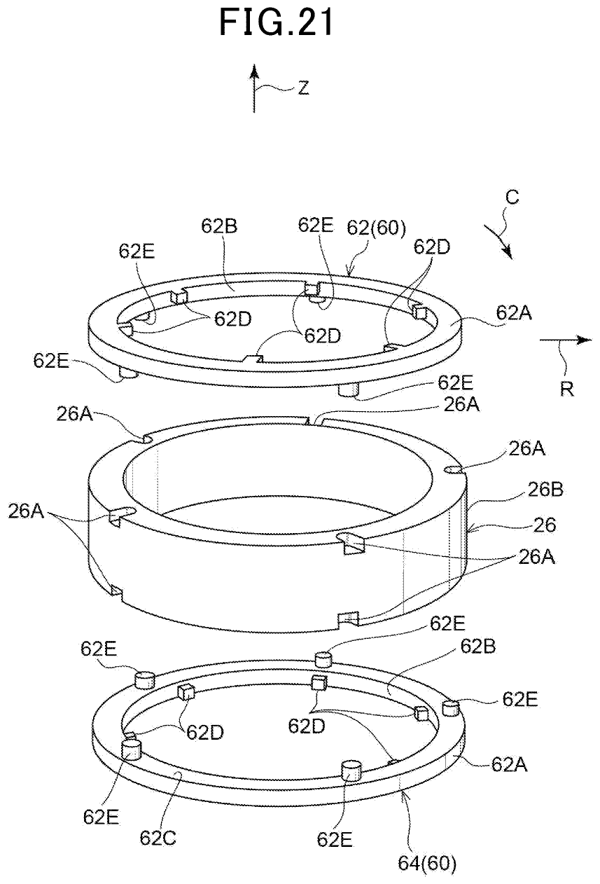

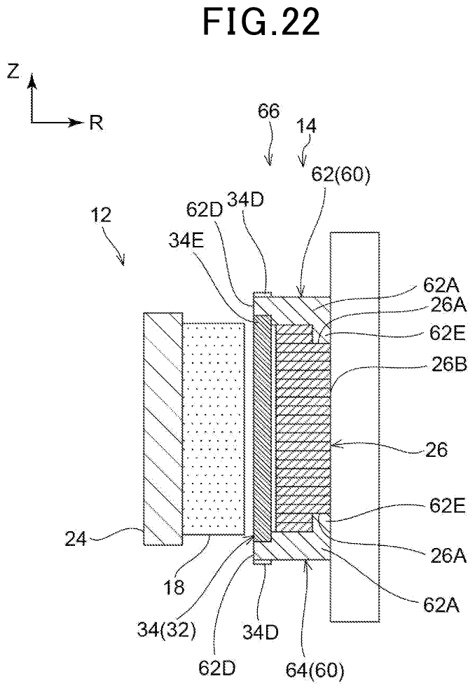

As shown in FIGS. 21 and 22, in the motor 66 according to the second embodiment, the coil assembly support member 60 further includes a plurality of core-engaging protrusions 62E serving as third engagement portions. Moreover, in the stator core 26 of the motor 66 according to the second embodiment, there are formed a plurality of core-side recesses 26A serving as fourth engagement portions with which the core-engaging protrusions 62E respectively engage.

Specifically, the first support member 62 has a plurality of core-engaging protrusions 62E protruding from a surface of the support member main body 62A thereof on the second side in the axial direction toward the second side in the axial direction. More particularly, in the present embodiment, the first support member 62 has five core-engaging protrusions 62E arranged at equal intervals in the circumferential direction. Moreover, the five core-engaging protrusions 62E are formed in a cylindrical shape. In addition, the five core-engaging protrusions 62E are located at positions offset radially outward from a radial center position of the support member main body 62A.

Similarly, the second support member 64 has a plurality of core-engaging protrusions 62E protruding from a surface of the support member main body 62A thereof on the first side in the axial direction toward the first side in the axial direction. More particularly, in the present embodiment, the first support member 62 has five core-engaging protrusions 62E arranged at equal intervals in the circumferential direction. Moreover, the five core-engaging protrusions 62E are formed in a cylindrical shape. In addition, the five core-engaging protrusions 62E are located at positions offset radially outward from a radial center position of the support member main body 62A.

At the end of the stator core 26 on the first side in the axial direction, at the end (i.e., radially outer end) of the stator core 26 on the radial side where no coil assembly 32 is arranged, there are formed five core-side recesses 26A with which the five core-engaging protrusions 62E of the first support member 62 respectively engage. Each of the core-side recesses 26A is open on both the first side in the axial direction and the outer side in the radial direction.

Similarly, at the end of the stator core 26 on the second side in the axial direction, at the end (i.e., radially outer end) of the stator core 26 on the radial side where no coil assembly 32 is arranged, there are formed five core-side recesses 26A with which the five core-engaging protrusions 62E of the second support member 64 respectively engage. Each of the core-side recesses 26A is open on both the second side in the axial direction and the outer side in the radial direction.

In addition, defining that part of the stator core 26 which forms a magnetic path as a core main body 26B serving as an armature core main body, the core-side recesses 26A may be described as being formed in the core main body 26B.

The five core-engaging protrusions 62E of the first support member 62 are engaged respectively with the five core-side recesses 26A of the stator core 26 formed on the first side in the axial direction, while the five core-engaging protrusions 62E of the second support member 64 are engaged respectively with the five core-side recesses 26A of the stator core 26 formed on the second side in the axial direction. Consequently, the coil assembly support member 60 (i.e., the first support member 62 and the second support member 64) is positioned with respect to the stator core 26 in the circumferential direction while being mounted to the stator core 26. Hence, in the present embodiment, it becomes possible to position the coil assembly support member 60 with respect to the stator core 26 in the circumferential direction simply by mounting the coil assembly support member 60 to the stator core 26.

Moreover, in the present embodiment, the core-side recesses 26A are formed at the end of the stator core 26 (more specifically, the core main body 26B) on the radial side where no coil assembly 32 is arranged. Consequently, it becomes possible to lessen the adverse influence of the core-side recesses 26A on the characteristics of the motor 66 in comparison with a configuration in which the core-side recesses 26A are formed at the end of the stator core 26 (more specifically, the core main body 26B) on the radial side where the coil assembly 32 is arranged.

It should be noted that the number, shape and dimensions of the core-engaging protrusions 62E and the number, shape and dimensions of the core-side recesses 26A are not limited to those described above, but may be set properly in consideration of the dimensions of the stator core 26, and the like.

### Third Embodiment

Next, a motor 68 according to the third embodiment will be described. It should be noted that: members and parts of the motor 68 according to the third embodiment corresponding to those of the motor 10 according to the first embodiment are designated by the same reference signs as the corresponding members and parts of the motor 10 according to the first embodiment; and description of these parts and members will be omitted hereinafter.

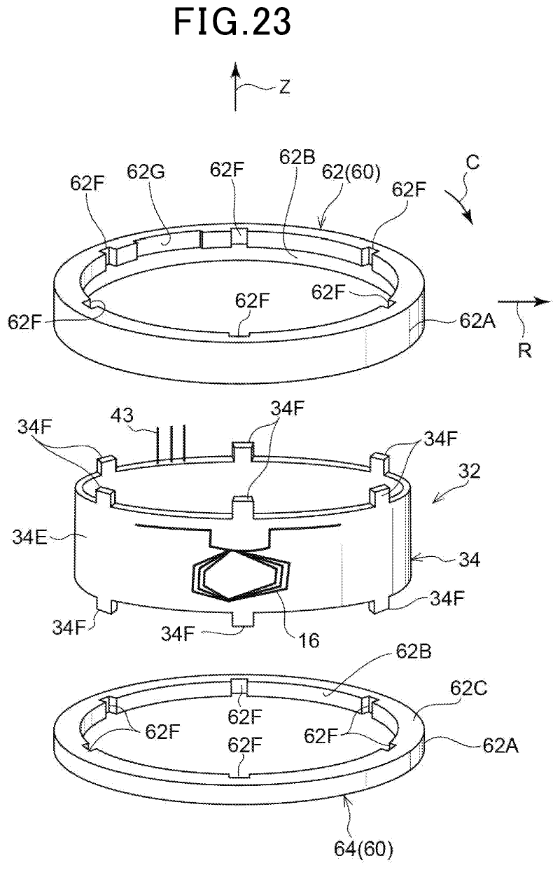

As shown in FIGS. 23, 24 and 25, in the motor 68 according to the third embodiment, coil-assembly-side protrusions 34F serving as the first engagement portions and support-member-side recesses 62F serving as the second engagement portions respectively correspond to the coil-assembly-side recesses 34D and the support-member-side protrusions 62D in the motor 10 according to the first embodiment.

Specifically, the first support member 62 has six support-member-side recesses 62F recessed radially outward from the radially inner surface of the support member main body 62A thereof. The six support-member-side recesses 62F are arranged at equal intervals in the circumferential direction. Moreover, each of the support-member-side recesses 62F is formed to have a rectangular shape when viewed in the axial direction. Furthermore, each of the support-member-side recesses 62F has a peripheral edge formed in a U-shape that is open on the radially inner side. In addition, in the first support member 62, there is formed a passage recess 62G through which the connection portions 43 of the coil assembly 32 pass in the axial direction. The passage recess 62G is also recessed radially outward from the radially inner surface of the support member main body 62A.

The second support member 64 also has six support-member-side recesses 62F respectively corresponding to the six support-member-side recesses 62F of the first support member 62.

At the end of the band member 34 of the coil assembly 32 on the first side in the axial direction, there are formed six coil-assembly-side protrusions 34F that respectively engage with the six support-member-side recesses 62F of the first support member 62. Similarly, at the end of the band member 34 of the coil assembly 32 on the second side in the axial direction, there are formed six coil-assembly-side protrusions 34F that respectively engage with the six support-member-side recesses 62F of the second support member 64. Each of the coil-assembly-side protrusions 34F is formed to have a rectangular shape when viewed from the radially inner side. In addition, defining the annularly-rolled part of the band member 34 as the band member main body 34E, the coil-assembly-side protrusions 34F may be described as protruding from the band member main body 34E toward the first side or the second side in the axial direction.

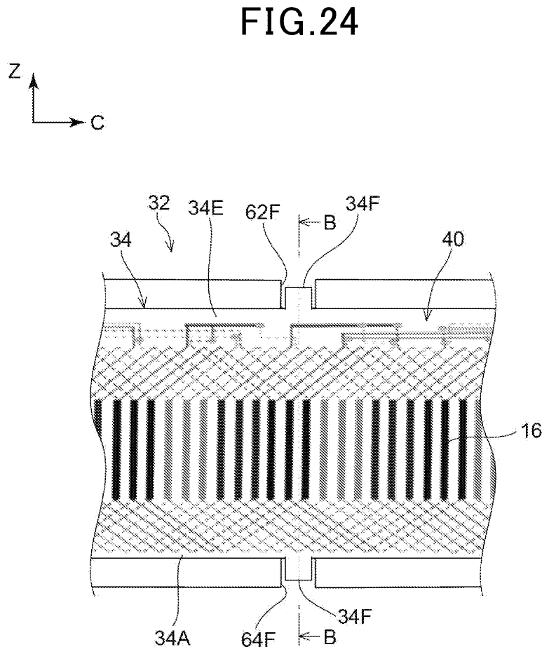

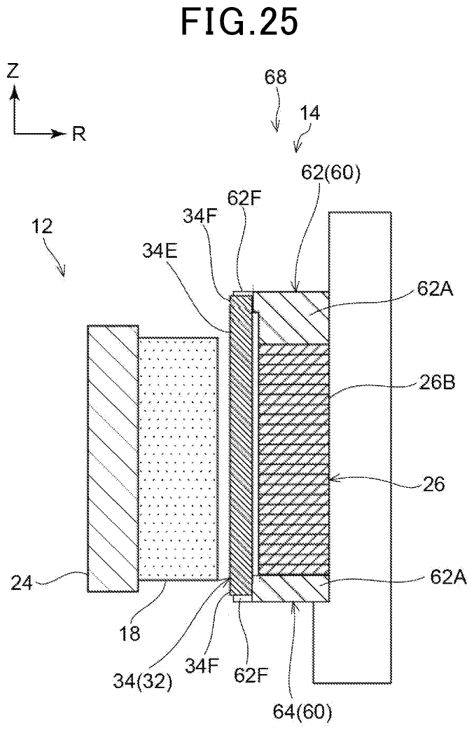

As shown in FIGS. 24 and 25, the six support-member-side recesses 62F of the first support member 62 are engaged respectively with the six coil-assembly-side protrusions 34F formed at the end of the band member 34 of the coil assembly 32 on the first side in the axial direction. On the other hand, the six support-member-side recesses 62F of the second support member 64 are engaged respectively with the six coil-assembly-side protrusions 34F formed at the end of the band member 34 of the coil assembly 32 on the second side in the axial direction. Consequently, the coil assembly 32 is supported by the stator core 26 via the coil assembly support member 60 (i.e., the first support member 62 and the second support member 64). Moreover, by the coil assembly support member 60 (i.e., the first support member 62 and the second support member 64), the coil assembly 32 is positioned with respect to the stator core 26 in the circumferential, axial and radial directions. Hence, in the present embodiment, with the coil assembly support member 60 (i.e., the first support member 62 and the second support member 64), it becomes possible to secure the positional accuracy of the coil assembly 32 with respect to the stator core 26 simply by assembling the stator 14 in a predetermined procedure.

Moreover, in the present embodiment, each of the coil-assembly-side protrusions 34F is configured to protrude from the annularly-rolled band member main body 34E. Consequently, it becomes possible to have the coil assembly 32 supported by the stator core 26 via the coil assembly support member 60 (i.e., the first support member 62 and the second support member 64) while suppressing the adverse influence of the coil-assembly-side protrusions 34F on the coils 16 and the connection pattern section 40 formed on the band member 34 (more specifically, on the band member main body 34E).

It should be noted that the number, shape and dimensions of the coil-assembly-side protrusions 34F and the number, shape and dimensions of the support-member-side recesses 62F are not limited to those described above, but may be set properly in consideration of the size of the motor 10, the torque generated in the coil assembly 32, and the like.

### Fourth Embodiment

Next, a motor according to the fourth embodiment will be described. It should be noted that: members and parts of the motor according to the fourth embodiment corresponding to those of the motor 10 according to the first embodiment are designated by the same reference signs as the corresponding members and parts of the motor 10 according to the first embodiment; and description of these parts and members will be omitted hereinafter.

FIG. 26 is an enlarged cross-sectional view schematically showing a cross section of an insulator 28 that constitutes a part of the motor according to the fourth embodiment. As shown in FIG. 26, the insulator 28 includes a substrate 50 formed of an electrically-insulative material and soft-magnetic portions 52 formed of a soft-magnetic material in the substrate 50. It should be noted that in the present embodiment, the entire insulator 28 is configured to have the soft-magnetic portions 52 included in the substrate 50. As an example, the substrate 50 may be formed of a resin material. On the other hand, the soft-magnetic portions 52 may be formed of atomized powder of a soft-magnetic metal such as iron. With the above configuration, magnetic flux generated by the magnets 18 can be introduced to the stator core 26 via the soft-magnetic portions 52 of the insulator 28, thereby reducing the magnetic reluctance between the magnets 18 and the stator core 26. As a result, it becomes possible to effectively use the magnetic flux generated by the magnets 18, thereby achieving improvement in the torque of the motor and reduction in the size of the motor.

### Fifth Embodiment

Next, a motor according to the fifth embodiment will be described. It should be noted that: members and parts of the motor according to the fifth embodiment corresponding to those of the motor 10 according to the first embodiment are designated by the same reference signs as the corresponding members and parts of the motor 10 according to the first embodiment; and description of these parts and members will be omitted hereinafter.

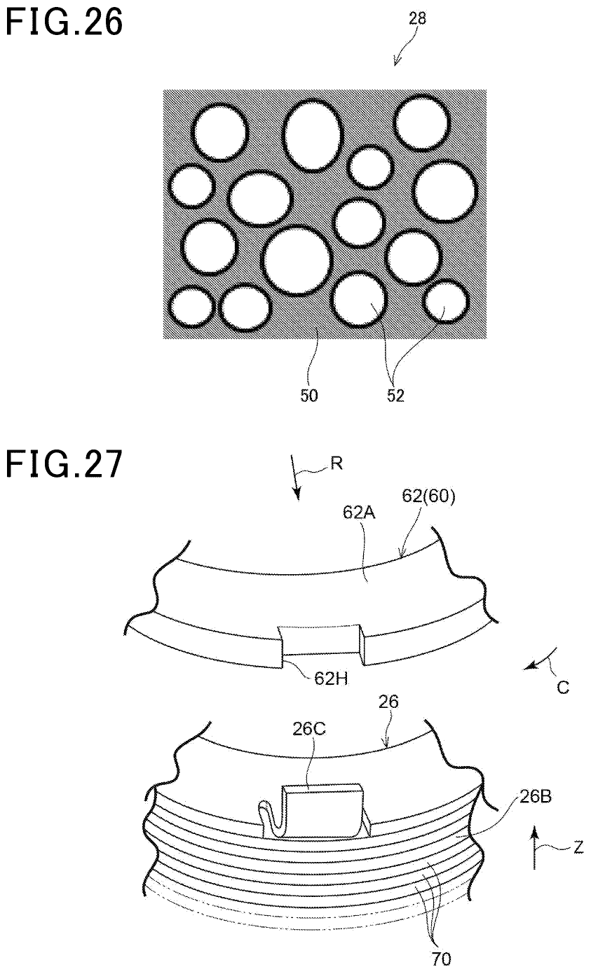

As shown in FIG. 27, in the motor according to the fifth embodiment, the coil assembly support member 60 includes a plurality of core-engaging recesses 62H serving as the third engagement portions. Moreover, in the motor according to the fifth embodiment, the stator core 26 includes a plurality of core-side protrusions 26C serving as the fourth engagement portions that respectively engage with the core-engaging recesses 62H.

Specifically, at a radially outer end of the support member main body 62A of the first support member 62, there are formed core-engaging recesses 62H. Each of the core-engaging recesses 62H is formed to have a rectangular shape when viewed in the axial direction. Moreover, each of the core-engaging recesses 62H has a peripheral edge formed in a U-shape that is open on the radially outer side.

On the other hand, at the end of the stator core 26 on the first side in the axial direction, at the end (i.e., radially outer end) of the stator core 26 on the radial side where no coil assembly 32 is arranged, there are formed tongue-shaped core-side protrusions 26C that protrude toward the first side in the axial direction. Each of the core-side protrusions 26C is formed to have a rectangular shape when viewed in the radial direction.

Defining that part of the stator core 26 which forms a magnetic path as a core main body 26B serving as an armature core main body, the core-side protrusions 26C may be described as protruding from the core main body 26B. In the present embodiment, the stator core 26 is formed by laminating a plurality of core-forming sheets 70, which are cut into a predetermined shape, in the axial direction and integrating them into one piece. At the radially outer end of that one of the core-forming sheets 70 which is located at the end on the first side in the axial direction, there are provided tongue-shaped portions. The tongue-shaped portions are bent toward the first side in the axial direction, forming the core-side protrusions 26C.

The core-side protrusions 26C formed at the end of the stator core 26 on the first side in the axial direction are engaged respectively with the core-engaging recesses 62H of the first support member 62. Consequently, the coil assembly support member 60 (i.e., the first support member 62) is positioned with respect to the stator core 26 in the circumferential direction while being mounted to the stator core 26. Hence, in the present embodiment, it becomes possible to position the coil assembly support member 60 with respect to the stator core 26 in the circumferential direction simply by mounting the coil assembly support member 60 to the stator core 26.

Moreover, in the present embodiment, the core-side protrusions 26C are formed, at the end of the stator core 26 (more specifically, the core main body 26B) on the radial side where no coil assembly 32 is arranged, to protrude from the core main body 26B. Consequently, it becomes possible to lessen the adverse influence of the core-side protrusions 26C on the characteristics of the motor in comparison with a configuration in which the core side protrusions 26C are formed at the end of the stator core 26 (more specifically, the core main body 26B) on the radial side where the coil assembly 32 is arranged.

It should be noted that the number, shape and dimensions of the core-engaging recesses 62H and the number, shape and dimensions of the core-side protrusions 26C are not limited to those described above, but may be set properly in consideration of the dimensions of the stator core 26, and the like. It also should be noted that core-engaging recesses 62H may be provided in the second support member 64 (not shown) and core-side protrusions 26C may be provided at the end of the stator core 26 on the second side in the axial direction.

### Sixth and Seventh Embodiments

Next, a motor 72 according to the sixth embodiment and a motor 74 according to the seventh embodiment will be described. It should be noted that: members and parts of the motors 72 and 74 according to the sixth and seventh embodiments corresponding to those of the motor 10 according to the first embodiment are designated by the same reference signs as the corresponding members and parts of the motor 10 according to the first embodiment; and description of these parts and members will be omitted hereinafter.

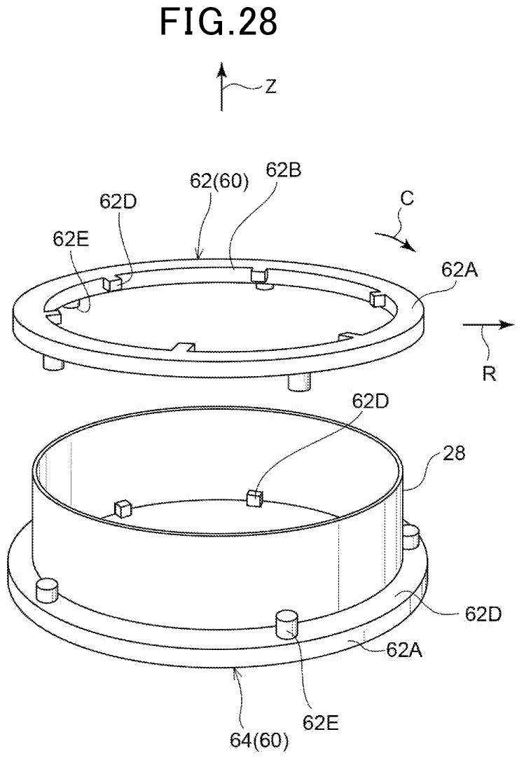

As shown in FIGS. 28 and 29 and FIGS. 30 and 31, in the motor 72 according to the sixth embodiment and the motor 74 according to the seventh embodiment, the coil assembly support member 60 and the insulator 28 are formed integrally with each other.

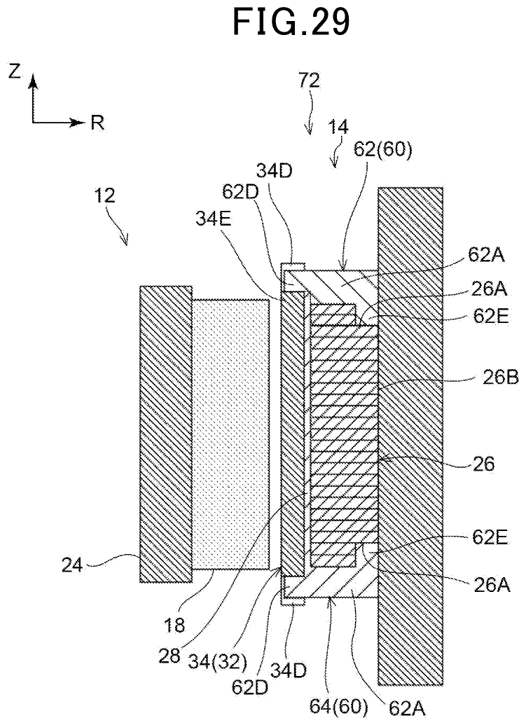

As shown in FIGS. 28 and 29, in the motor 72 according to the sixth embodiment, the insulator 28 is formed integrally with, of the first support member 62 and the second support member 64 that together constitute the coil assembly support member 60, the second support member 64. Specifically, the insulator 28 is formed in a cylindrical shape extending from a radially inner end portion of the support member main body 62A of the second support member 64 toward the first side in the axial direction.

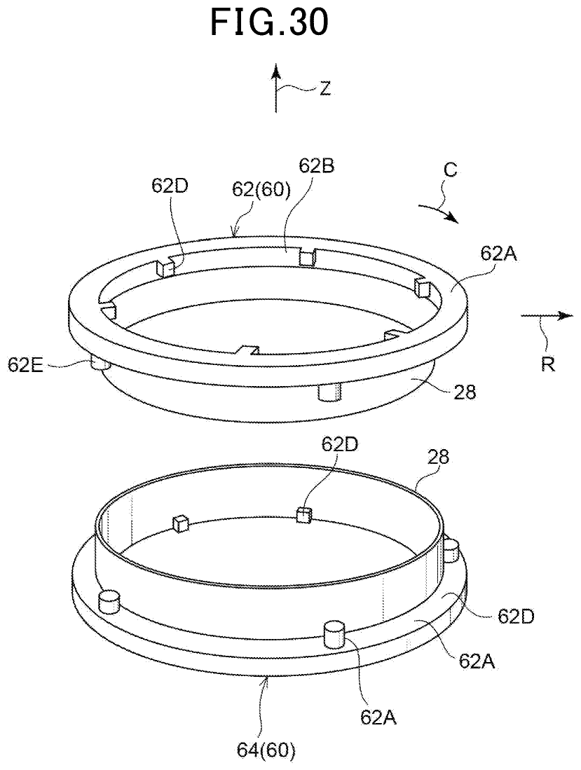

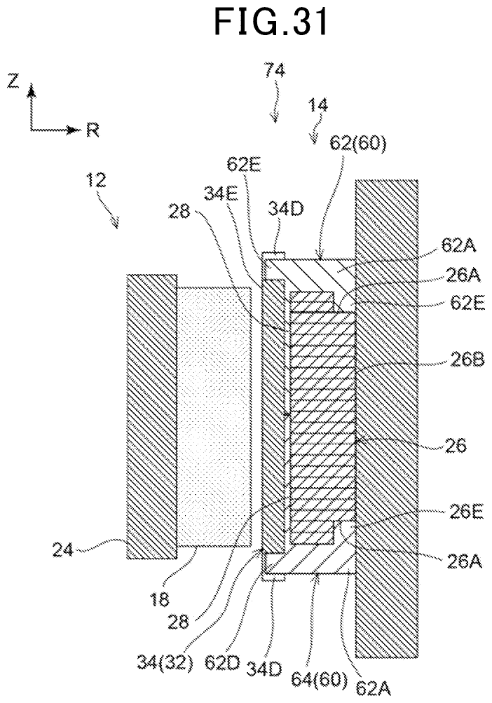

As shown in FIGS. 30 and 31, in the motor 74 according to the seventh embodiment, the insulator 28 is divided into two parts in the axial direction; and the two parts of the insulator 28 are formed respectively integrally with the first support member 62 and the second support member 64 that together constitute the coil assembly support member 60. Specifically, the part of the insulator 28 on the first side in the axial direction is formed in a cylindrical shape extending from a radially inner end portion of the support member main body 62A of the first support member 62 toward the second side in the axial direction. On the other hand, the part of the insulator 28 on the second side in the axial direction is formed in a cylindrical shape extending from a radially inner end portion of the support member main body 62A of the second support member 64 toward the first side in the axial direction.

As above, in the motor 72 according to the sixth embodiment and the motor 74 according to the seventh embodiment, the coil assembly support member 60 and the insulator 28 are formed integrally with each other. Consequently, it becomes possible to reduce the number of parts of the motors 72 and 74.

### Eighth and Ninth Embodiments

Next, motors according to the eighth and ninth embodiments will be described. It should be noted that: members and parts of the motors according to the eighth and ninth embodiments corresponding to those of the motor 10 according to the first embodiment are designated by the same reference signs as the corresponding members and parts of the motor 10 according to the first embodiment; and description of these parts and members will be omitted hereinafter.

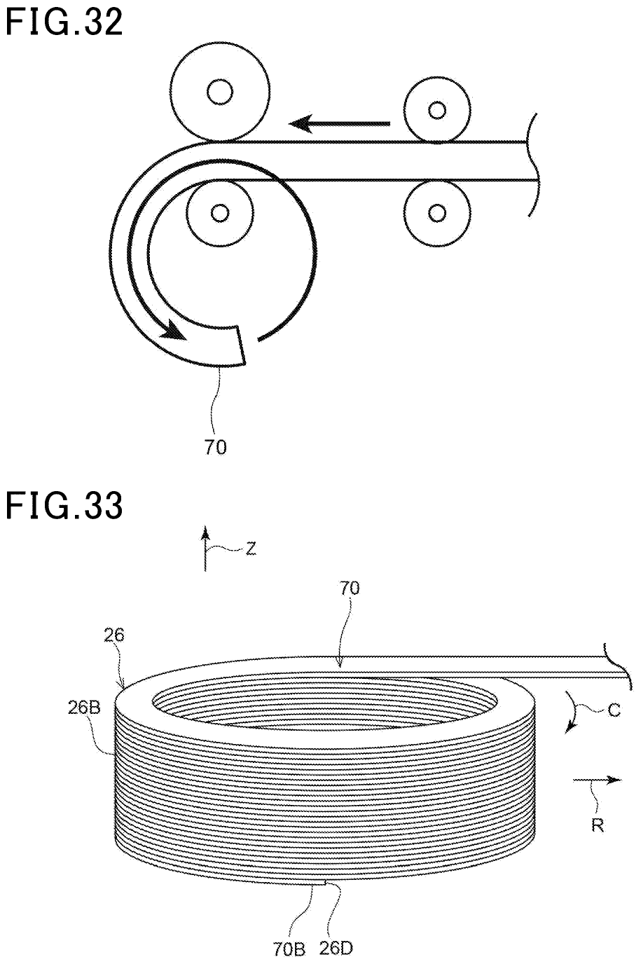

As shown in FIGS. 32 to 35, the stator core 26 of the motor according to the eighth embodiment is formed by laminating a core-forming sheet 70, whose thickness direction coincides with the axial direction, in the axial direction while winding it in the circumferential direction into an annular shape. It should be noted that in the present embodiment, the core-forming sheet 70 is seamlessly wound in the circumferential direction. Moreover, as shown in FIG. 35, at the end of the stator core 26 on the first side in the axial direction, there is formed a core-side step portion 26D between the core main body 26B and a first end portion 70A of the core-forming sheet 70; the core-side step portion 26D has a height difference in the axial direction and serves as a fourth engagement portion. Similarly, at the end of the stator core 26 on the second side in the axial direction, there is formed a core-side step portion 26D between the core main body 26B and a second end portion 70B of the core-forming sheet 70; the core-side step portion 26D has a height difference in the axial direction and serves as a fourth engagement portion.

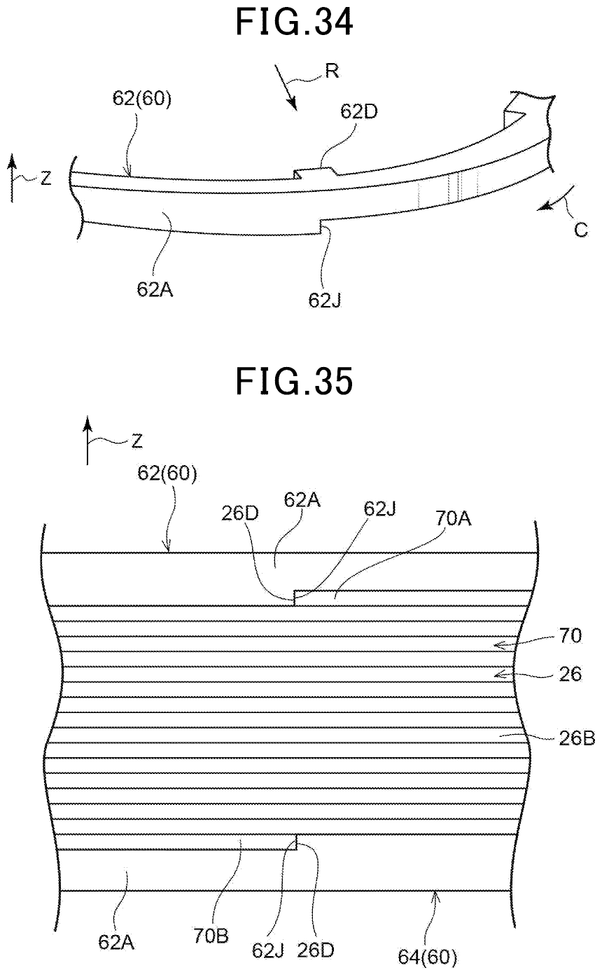

On the other hand, as shown in FIGS. 34 and 35, at the end of the support member main body 62A of the first support member 62 on the second side in the axial direction, there is formed a support-member-side step portion 62J that has a height difference in the axial direction and serves as a third engagement portion. Similarly, at the end of the support member main body 62A of the second support member 64 on the first side in the axial direction, there is also formed a support-member-side step portion 62J that has a height difference in the axial direction and serves as a third engagement portion.

Moreover, the support-member-side step portion 62J of the first support member 62 is engaged with the core-side step portion 26D of the stator core 26 formed on the first side in the axial direction, while the support-member-side step portion 62J of the second support member 64 is engaged with the core-side step portion 26D of the stator core 26 formed on the second side in the axial direction. Consequently, the coil assembly support member 60 (i.e., the first support member 62 and the second support member 64) is positioned with respect to the stator core 26 in the circumferential direction while being mounted to the stator core 26. Hence, in the present embodiment, it becomes possible to position the coil assembly support member 60 with respect to the stator core 26 in the circumferential direction simply by mounting the coil assembly support member 60 to the stator core 26.

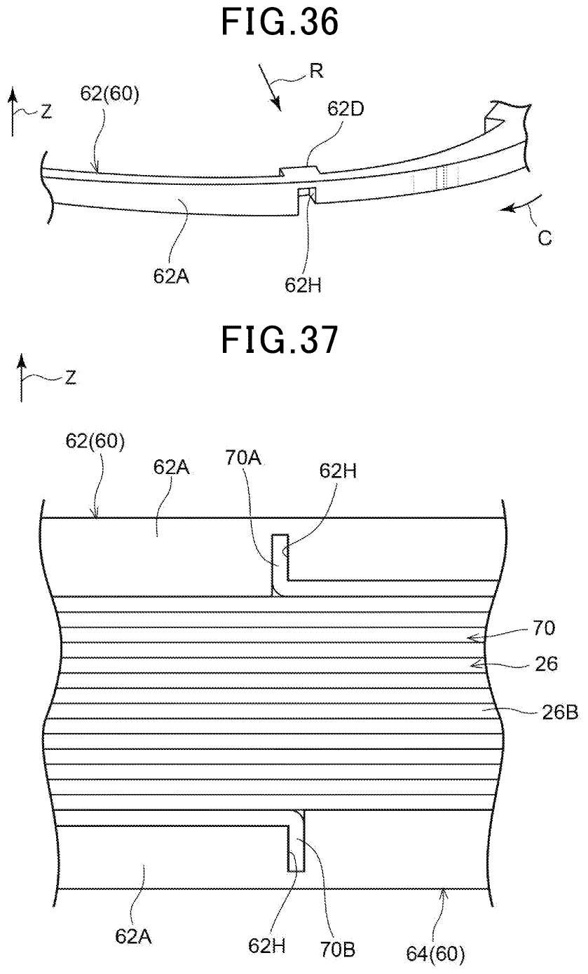

As shown in FIGS. 36 and 37, the stator core 26 of the motor according to the ninth embodiment is also formed by laminating a core-forming sheet 70 in the axial direction while winding it in the circumferential direction into an annular shape, similar to the stator core 26 of the motor according to the eighth embodiment. Moreover, at the end of the stator core 26 on the first side in the axial direction, a first end portion 70A of the core-forming sheet 70 is bent to protrude from the core main body 26B toward the first side in the axial direction (i.e., toward the first support member 62). Similarly, at the end of the stator core 26 on the second side in the axial direction, a second end portion 70B of the core-forming sheet 70 is bent to protrude from the core main body 26B toward the second side in the axial direction (i.e., toward the second support member 64). In addition, the first and second end portions 70A and 70B of the core-forming sheet 70 serve as fourth engagement portions.

On the other hand, at the end of the support member main body 62A of the first support member 62 on the second side in the axial direction, there is formed a core-engaging recess 62H that is open on the second side in the axial direction. Similarly, at the end of the support member main body 62A of the second support member 64 on the first side in the axial direction, there is formed a core-engaging recess 62H that is open on the first side in the axial direction.

Moreover, the core-engaging recess 62H of the first support member 62 is engaged with the first end portion 70A of the core-forming sheet 70 on the first side of the stator core 26 in the axial direction, while the core-engaging recess 62H of the second support member 64 is engaged with the second end portion 70B of the core-forming sheet 70 on the second side of the stator core 26 in the axial direction. Consequently, the coil assembly support member 60 (i.e., the first support member 62 and the second support member 64) is positioned with respect to the stator core 26 in the circumferential direction while being mounted to the stator core 26. Hence, in the present embodiment, it becomes possible to position the coil assembly support member 60 with respect to the stator core 26 in the circumferential direction simply by mounting the coil assembly support member 60 to the stator core 26.

In addition, with the configuration of the motor according to the ninth embodiment where the core-engaging recess 62H of the first support member 62 is engaged with the first end portion 70A of the core-forming sheet 70 and the core-engaging recess 62H of the second support member 64 is engaged with the second end portion 70B of the core-forming sheet 70, it is possible to cope with higher torque than with the configuration of the motor according to the eighth embodiment.

### Tenth and Eleventh Embodiments

Next, a motor 76 according to the tenth embodiment and a motor 78 according to the eleventh embodiment will be described. It should be noted that: members and parts of the motors 76 and 78 according to the tenth and eleventh embodiments corresponding to those of the motor 10 according to the first embodiment are designated by the same reference signs as the corresponding members and parts of the motor 10 according to the first embodiment; and description of these parts and members will be omitted hereinafter.

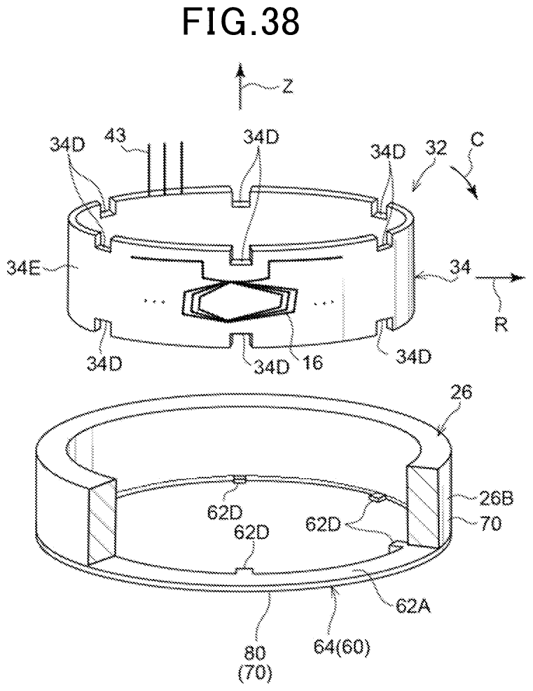

As shown in FIGS. 38 and 39 and FIGS. 40 and 41, in the motor 76 according to the tenth embodiment and the motor 78 according to the eleventh embodiment, part of the stator core 26 serves as the coil assembly support member 60.

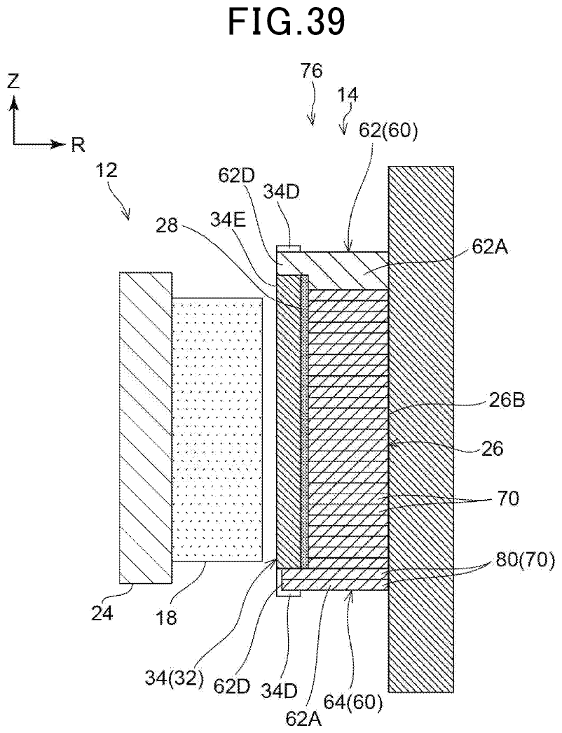

As shown in FIGS. 38 and 39, the stator core 26 of the motor 76 according to the tenth embodiment is formed by laminating a plurality of core-forming sheets 70, which are cut into a predetermined shape, in the axial direction and integrating them into one piece. Moreover, of the plurality of core-forming sheets 70, those two core-forming sheets 70 which are located at the end of the stator core 26 on the second side in the axial direction have a different shape from the other core-forming sheets 70. Hereinafter, those two core-forming sheets 70 which are located at the end of the stator core 26 on the second side in the axial direction will be referred to as the coil assembly support sheets 80. The two coil assembly support sheets 80, which together correspond to the second support member 64 of the motor 10 according to the first embodiment, form a support member main body 62A and six support-member-side protrusions 62D.

On the other hand, the first support member 62 of the motor 76 according to the tenth embodiment has the same configuration as the first support member 62 of the motor 10 according to the first embodiment.

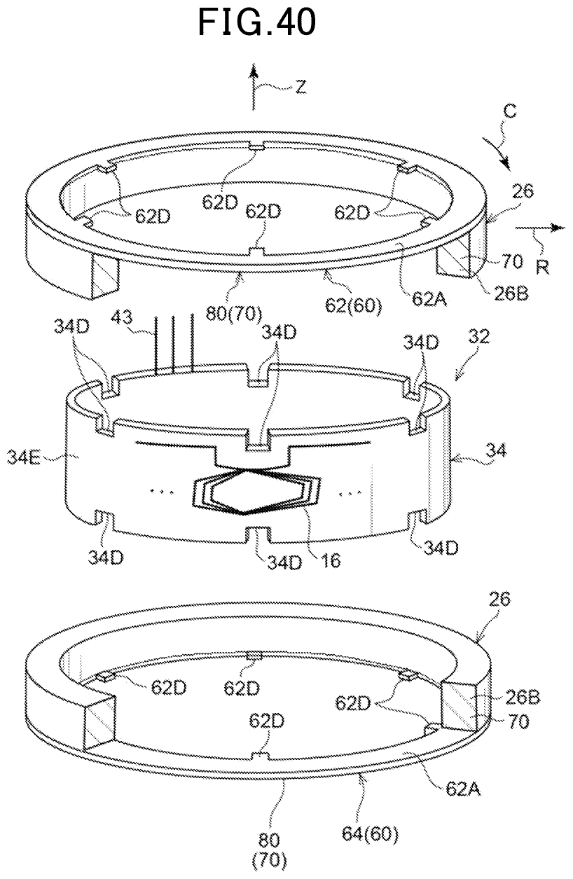

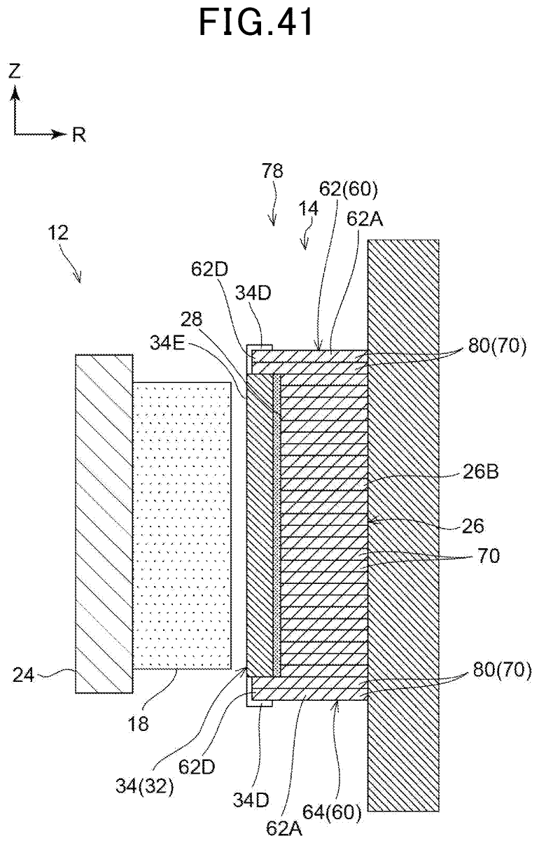

As shown in FIGS. 40 and 41, in the stator core 26 of the motor 78 according to the eleventh embodiment, of the plurality of core-forming sheets 70, those two core-forming sheets 70 which are located at the end of the stator core 26 on the first side in the axial direction serve as two coil assembly support sheets 80; and those two core-forming sheets 70 which are located at the end of the stator core 26 on the second side in the axial direction serve as another two coil assembly support sheets 80. That is, those two core-forming sheets 70 which are located at the end of the stator core 26 on the first side in the axial direction together constitute the first support member 62; and those two core-forming sheets 70 which are located at the end of the stator core 26 on the second side in the axial direction together constitute the second support member 64.

As described above, in the motor 76 according to the tenth embodiment and the motor 78 according to the eleventh embodiment, it becomes possible to have part of the stator core 26 functioning as the coil assembly support member 60.

Moreover, in the motor 76 according to the tenth embodiment and the motor 78 according to the eleventh embodiment, it also becomes possible to adjust the cogging torques of the motors 76 and 78 by adjusting the number, arrangement and shape of the support-member-side protrusions 62D of the coil assembly support sheets 80. In addition, for each of the motors 76 and 78, it is desirable to set the number of the support-member-side protrusions 62D to an integer multiple of a prime number that is not a prime factor of the number of magnetic poles of the motor or to set the number of magnetic poles of the motor to an integer multiple of a prime number that is not a prime factor of the number of the support-member-side protrusions 62D. In this case, it will become possible to reduce the cogging torques of the motors 76 and 78. It should be noted that the circumferential positions (or angles) of the support-member-side protrusions 62D may be spaced either at equal intervals or at unequal intervals. It also should be noted that the support-member-side protrusions 62D do not necessarily have a simple rectangular shape when viewed in the axial direction, but may have their corners rounded or chamfered.

It also should be noted that instead of the support-member-side protrusions 62D, the support-member-side recesses 62F of the motor 68 according to the third embodiment may be formed in the coil assembly support sheets 80. With the support-member-side recesses 62F formed in the coil assembly support sheets 80, it is possible to support the coil assembly 32 of the motor 68 according to the third embodiment.

### Twelfth Embodiment

Next, a motor according to a twelfth embodiment will be described. It should be noted that: members and parts of the motor according to the twelfth embodiment corresponding to those of the motor 10 according to the first embodiment are designated by the same reference signs as the corresponding members and parts of the motor 10 according to the first embodiment; and description of these parts and members will be omitted hereinafter.

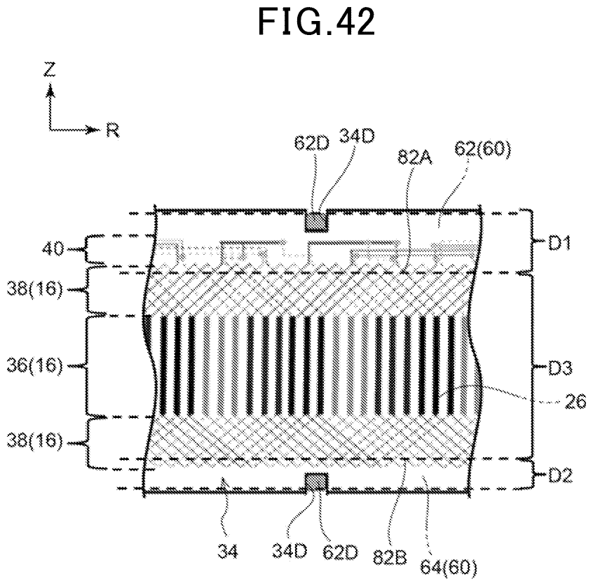

As shown in FIG. 42, the motor according to the twelfth embodiment has the same basic configuration as the motor 10 according to the first embodiment. FIG. 42 is a view, from the radially inner side, of the stator 14 of the motor according to the twelfth embodiment. As shown in this figure, in the present embodiment, the first support member 62 is located on the opposite side of an axial position 82A to the stator core 26 (i.e., on the first side of the axial position 82A in the axial direction); the axial position 82A is a position which is near the ends of the first coil end portions 38 of the coils 16 of the coil assembly 32 on the first side in the axial direction and at which the first support member 62 may or may not partially overlap the first coil end portions 38 in the radial direction. That is, the first support member 62 is arranged in the axial range indicated by D1 in FIG. 42. On the other hand, the second support member 64 is located on the opposite side of an axial position 82B to the stator core 26 (i.e., on the second side of the axial position 82B in the axial direction); the axial position 82B is a position which is near the ends of the second coil end portions 38 of the coils 16 of the coil assembly 32 on the second side in the axial direction and at which the second support member 64 may or may not partially overlap the second coil end portions 38 in the radial direction. That is, the second support member 64 is arranged in the axial range indicated by D2 in FIG. 42. In addition, the stator core 26 is arranged in the axial range indicated by D3 in FIG. 42.

With the above-described configuration, the coil assembly support member 60 (i.e., the first support member 62 and the second support member 64) is located at positions not radially overlapping the vertical portions 36 of the coils 16 of the coil assembly 32.

As described above, in the present embodiment, the coil assembly support member 60 (i.e., the first support member 62 and the second support member 64) is arranged at positions not radially overlapping the vertical portions 36 of the coils 16 of the coil assembly 32. Moreover, the coil assembly support member 60 (i.e., the first support member 62 and the second support member 64) is formed of a nonmagnetic material such as a resin material. Consequently, magnetic flux at the axial ends of the magnets 18 is prevented from flowing toward the coil assembly support member 60. That is, magnetic flux at the axial ends of the magnets 18 is prevented from becoming leakage magnetic flux. As a result, it becomes possible to suppress decrease in the output of the motor.

Furthermore, since the coil assembly support member 60 is formed of a resin material, it becomes possible to suppress increase in the weight of the motor in comparison with the case of the coil assembly support member 60 being formed of a metal material. It should be noted that the resin material of which the coil assembly support member 60 is formed may be mixed with a reinforcement filler such as glass fiber. It also should be noted that the coil assembly support member 60 may alternatively be formed of a molding material whose base material is rubber, ceramic, paper or wood.

### Thirteenth, Fourteenth and Fifteenth Embodiments

Next, a motor 88 according to the thirteenth embodiment, a motor 90 according to the fourteenth embodiment and a motor 92 according to the fifteenth embodiment will be described. It should be noted that: members and parts of the motors 88, 90 and 92 according to the thirteenth, fourteenth and fifteenth embodiments corresponding to those of the motor 10 according to the first embodiment are designated by the same reference signs as the corresponding members and parts of the motor 10 according to the first embodiment; and description of these parts and members will be omitted hereinafter.

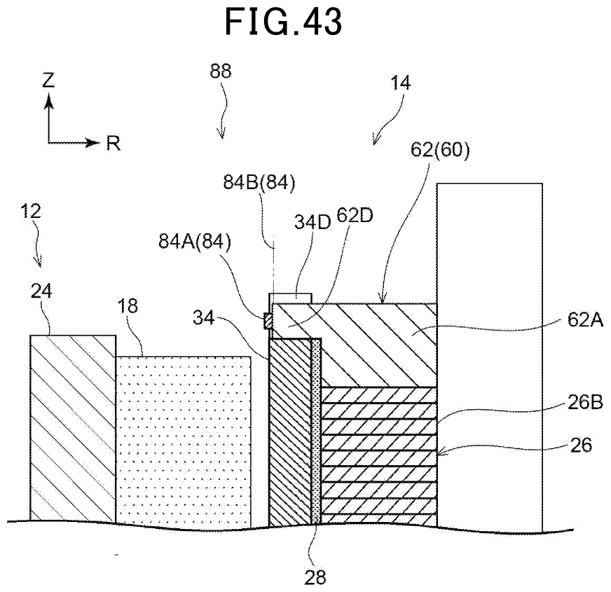

As shown in FIGS. 43, 44 and 45, in each of the motor 88 according to the thirteenth embodiment, the motor 90 according to the fourteenth embodiment and the motor 92 according to the fifteenth embodiment, a sensor 84 is mounted to the first support member 62. The sensor 84 has a sensor main body 84A formed in a rectangular block shape and a sensor wiring part 84B protruding from the sensor main body 84A. In addition, the sensor 84 may be, for example, a magnetic sensor for detecting rotation of the rotor 12, a temperature sensor for detecting temperature and an acceleration sensor for detecting vibration.

Specifically, as shown in FIG. 43, the motor 88 according to the thirteenth embodiment, a sensor 84 has its sensor main body 84A fixed to the radially inner surface of one of the support-member-side protrusions 62D of the first support member 62. Consequently, in the case of the sensor 84 being a magnetic sensor, the magnetism of the magnets 18 of the rotor 12 can be accurately detected by the sensor 84.

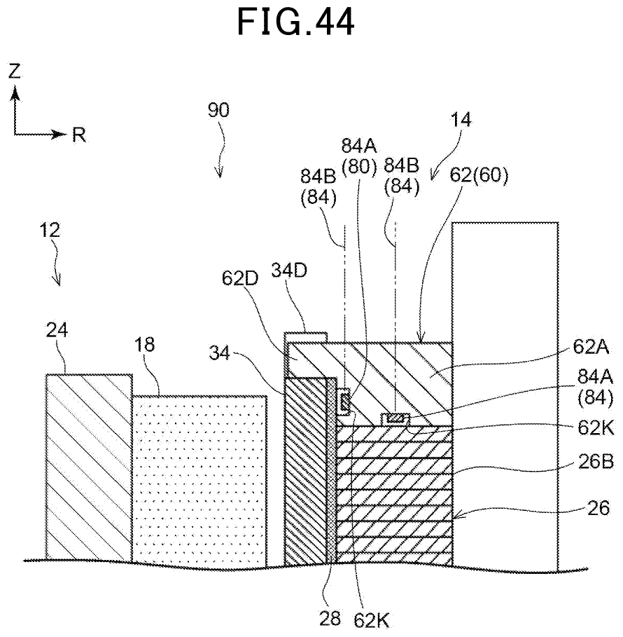

As shown in FIG. 44, in the motor 90 according to the fourteenth embodiment, first and second sensor arrangement recesses 62K are formed respectively at the end of the support member main body 62A of the first support member 62 on the second side in the axial direction and the radially inner end of the support member main body 62A of the first support member 62. Moreover, the sensor main body 84A of a first sensor 84 is arranged in the first sensor arrangement recess 62K formed at the end of the support member main body 62A of the first support member 62 on the second side in the axial direction, and fixed to the support member main body 62A of the first support member 62. On the other hand, the sensor main body 84A of a second sensor 84 is arranged in the second sensor arrangement recess 62K formed at the radially inner end of the support member main body 62A of the first support member 62, and fixed to the support member main body 62A of the first support member 62. Thus, the sensor main body 84A of the second sensor 84 is arranged in close proximity to the coil assembly 32. Consequently, in the case of the second sensor 84 being a temperature sensor, the temperature of the coil assembly 32 can be accurately detected by the second sensor 84.

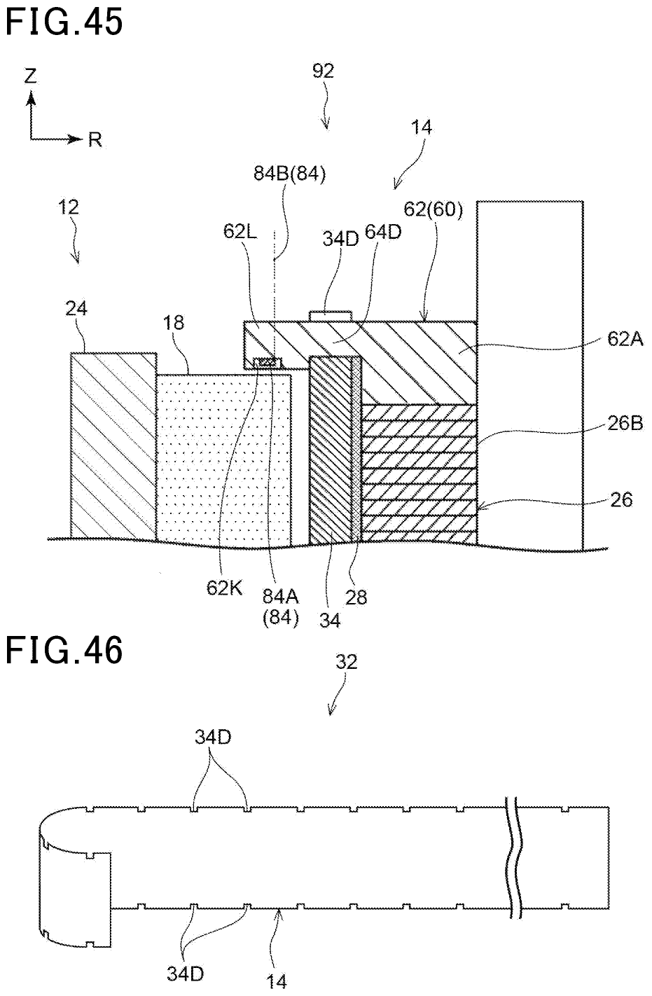

As shown in FIG. 45, in the motor 92 according to the fifteenth embodiment, the first support member 62 has a sensor mounting portion 62L that protrudes radially inward from the radially inner end of one of the support-member-side protrusions 62D of the first support member 62. Moreover, a sensor arrangement recess 62K is formed at the end of the sensor mounting portion 62L on the second side in the axial direction. A sensor 84 has its sensor main body 84A arranged in the sensor arrangement recess 62K and fixed to the sensor mounting portion 62L. Thus, the sensor main body 84A of the sensor 84 is arranged in close proximity to the end faces of the magnets 18 of the rotor 12 on the first side in the axial direction. Consequently, in the motor 92 according to the fifteenth embodiment, in the case of the sensor 84 being a magnetic sensor, the magnetism of the magnets 18 of the rotor 12 can be more accurately detected by the sensor 84 than in the motor 88 according to the thirteenth embodiment.

### (Configuration and Method for Rolling Coil Assembly 32)

Next, the configuration and method for rolling the coil assembly 32 will be described.

FIG. 46 is a schematic diagram showing the coil assembly 32 before being rolled. The configuration of the coil assembly 32 shown in FIG. 46 is similar to that of the coil assembly 32 of the motor 10 according to the first embodiment described above. It should be noted that the coils 16 and the connection pattern section 40 are not shown in FIG. 46.

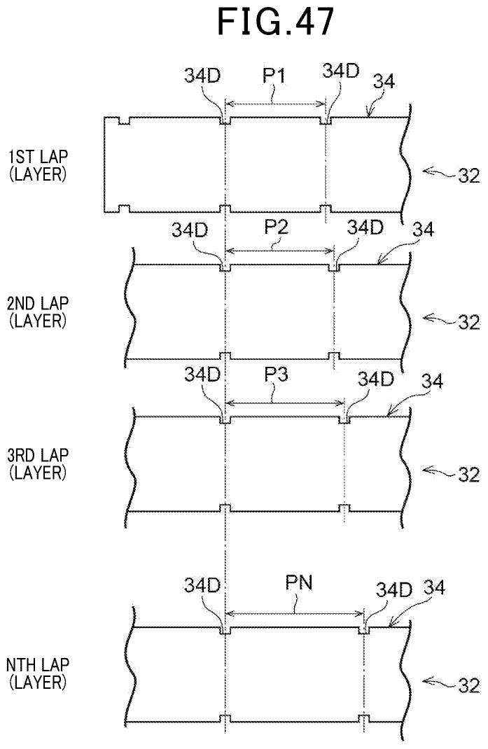

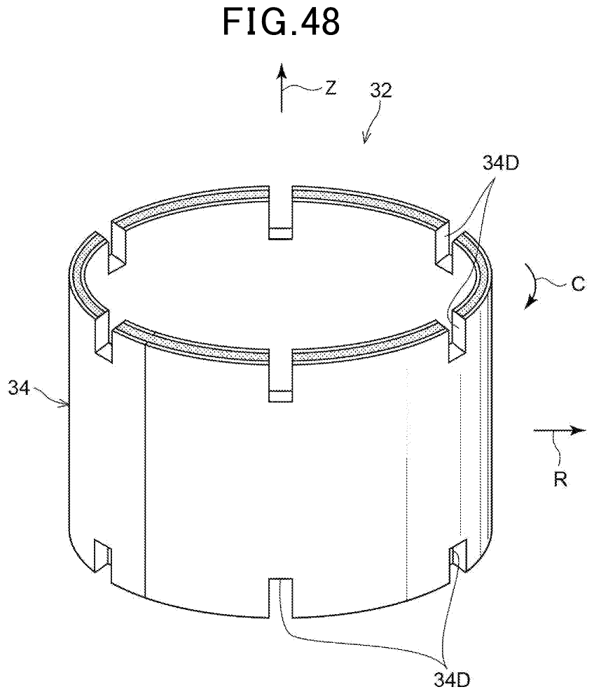

The coil assembly 32 is formed by rolling the band member 34 along the circumferential direction a plurality of times. Therefore, the circumferential length of that part of the band member 34 which constitutes the second lap of the band member 34 is greater than the circumferential length of that part of the band member 34 which constitutes the first lap of the band member 34. Moreover, the circumferential length of that part of the band member 34 which constitutes the third lap of the band member 34 is greater than the circumferential length of that part of the band member 34 which constitutes the second lap of the band member 34. That is, the circumferential length of that part of the band member 34 which constitutes the Nth lap of the band member 34 is greater than the circumferential length of that part of the band member 34 which constitutes the (N−1)th lap of the band member 34. In consideration of the above, as shown in FIG. 47, the circumferential intervals P2 between the coil-assembly-side recesses 34D formed in that part of the band member 34 which constitutes the second lap are set to be greater than the circumferential intervals P1 between the coil-assembly-side recesses 34D formed in that part of the band member 34 which constitutes the first lap. Moreover, the circumferential intervals P3 between the coil-assembly-side recesses 34D formed in that part of the band member 34 which constitutes the third lap are set to be greater than the circumferential intervals P2 between the coil-assembly-side recesses 34D formed in that part of the band member 34 which constitutes the second lap. That is, the circumferential intervals PN between the coil-assembly-side recesses 34D formed in part of the band member 34 which constitutes the Nth lap of the band member 34 are set to be greater than the circumferential intervals P(N−1) between the coil-assembly-side recesses 34D formed in that part of the band member 34 which constitutes the (N−1)th lap. Consequently, as shown in FIG. 48, after the band member 34 of the coil assembly 32 is rolled along the circumferential direction a plurality of times, the circumferential positions of corresponding ones of the coil-assembly-side recesses 34D formed respectively in the plurality of laps (or layers) of the band member 34 coincide with each other.

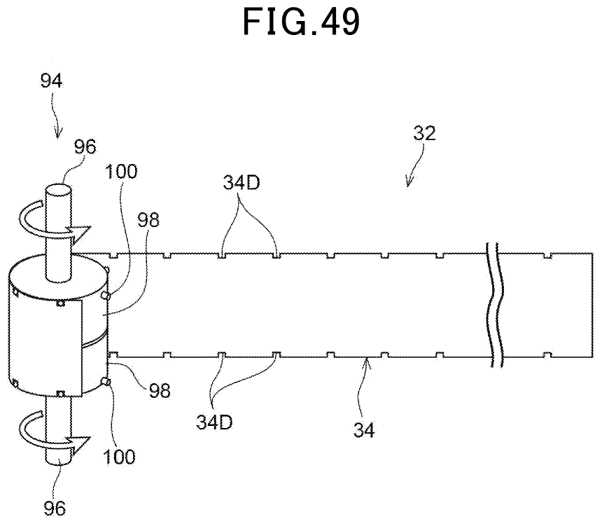

As shown in FIG. 49, the band member 34 of the coil assembly 32 described above is rolled using a jig 94. The jig 94 has a pair of shaft portions 96 supported rotatably and arranged coaxially with each other, and a pair of rollers 98 formed in a cylindrical shape and fixed respectively to the pair of shaft portions 96. The outer diameters of the pair of rollers 98 are set to be equal to each other. Hereinafter, of the pair of rollers 98, the roller 98 located on the first side in the axial direction will be referred to as the first roller 98; and the roller 98 located on the second side in the axial direction will be referred to as the second roller 98. To an end portion of the first roller 98 on the first side in the axial direction, there are fixed six pins 100 that protrude radially outward from the radially outer surface of the first roller 98. Similarly, to an end portion of the second roller 98 on the second side in the axial direction, there are fixed six pins 100 that protrude radially outward from the radially outer surface of the second roller 98. In addition, each of the pins 100 is formed in a cylindrical shape with its axial direction coinciding with a radial direction of the roller 98 to which the pin 100 is fixed.

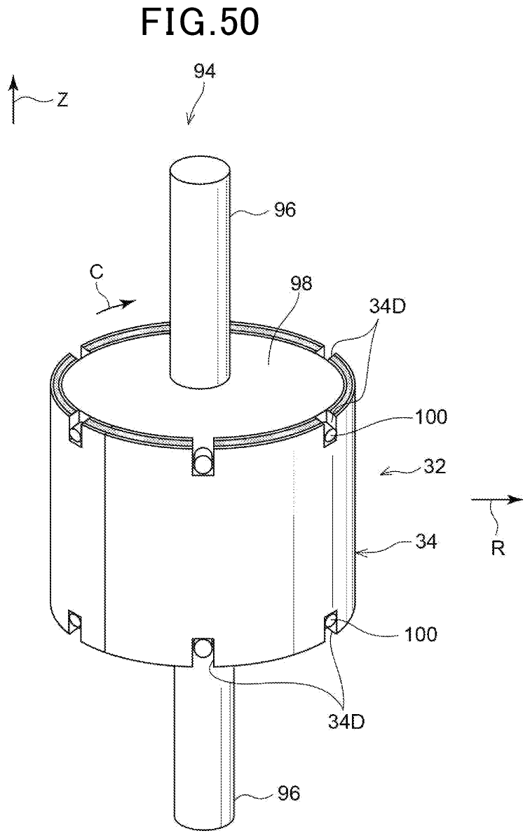

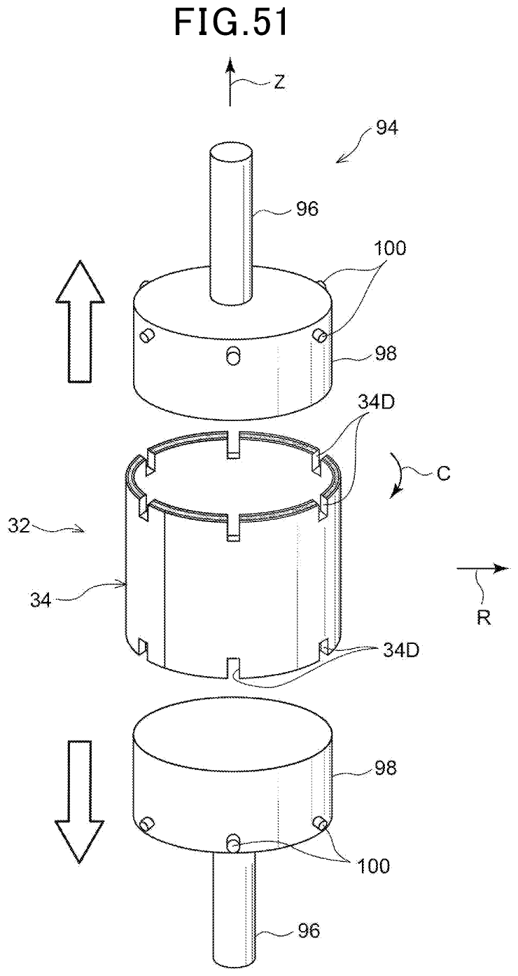

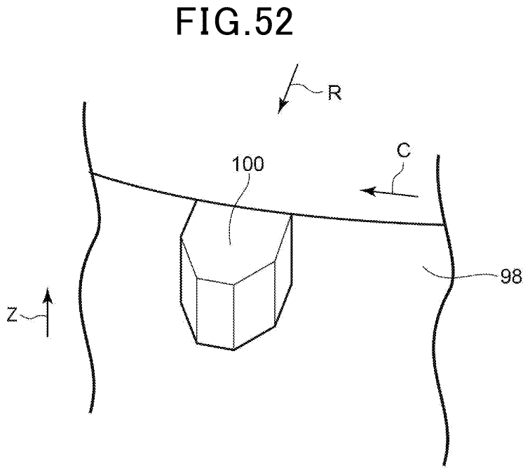

First, the pair of rollers 98 are coupled, in a state of being in contact with each other in the axial direction, so as to be rotatable together with each other. Then, an end portion of the band member 34 of the coil assembly 32 is arranged along the outer circumferential surfaces of the pair of rollers 98; and each of the pins 100 fixed to the pair of rollers 98 is engaged with a corresponding one of the coil-assembly-side recesses 34D formed in the end portion of the band member 34 of the coil assembly 32. Thereafter, the pair of rollers 98 are rotated. Consequently, as shown in FIG. 50, the band member 34 of the coil assembly 32 is rolled in a predetermined number of layers. Further, predetermined portions of the band member 34 of the coil assembly 32 are fixed by bonding, crimping, rivets, clips or the like. Consequently, the band member 34 of the coil assembly 32 is kept in the annularly-rolled state. Next, as shown in FIG. 51, the pair of rollers 98 are moved away from each other in the axial direction, thereby removing the coil assembly 32 (thus, the band member 34) from the jig 94. Through the above steps, the coil assembly 32 is manufactured.

In the case of the band member 34 having a plurality of coil-assembly-side recesses 34D in each lap, the pitch angles (or the circumferential intervals) between the plurality of coil-assembly-side recesses 34D may be constant (i.e., equal) or unequal. Moreover, in the case of the band member 34 of the coil assembly 32 being rolled in a plurality of laps, the band member 34 may be continuous or segmented in the circumferential direction. Further, the number of segmentations of the band member 34 in the circumferential direction may be set arbitrarily. For example, the band member 34 may be segmented once per lap, once every two laps or once every n laps. Furthermore, the intervals at which the band member 34 is segmented in the circumferential direction may be equal or unequal (e.g., 2 laps plus 3 laps). Moreover, in the case of the band member 34 being segmented in the circumferential direction into a plurality of segments, the segments may be spliced and rolled together in such a manner that after rolling one segment of the band member 34, the rollers 98 are further rotated with the coil-assembly-side recesses 34D of another segment of the band member 34 engaged with the corresponding pins 100. Furthermore, in the case of the coil-assembly-side recesses 34D formed in the band member 34 each having, for example, a circular opening, the pins 100 may be configured to be movable relative to the rollers 98, thereby allowing the rolled coil assembly 32 (thus the rolled band member 34) to be removed from the jig 94. For example, the pins 100 may be configured to be detachable from the rollers 98, or to be retractable into the rollers 98. Furthermore, as shown in FIG. 52, the circumferential dimension of each of the pins 100 may be set so as to decrease toward the radially outer side. In this case, the pins 100 can be easily engaged with the corresponding coil-assembly-side recesses 34D during rotation of the rollers 98.

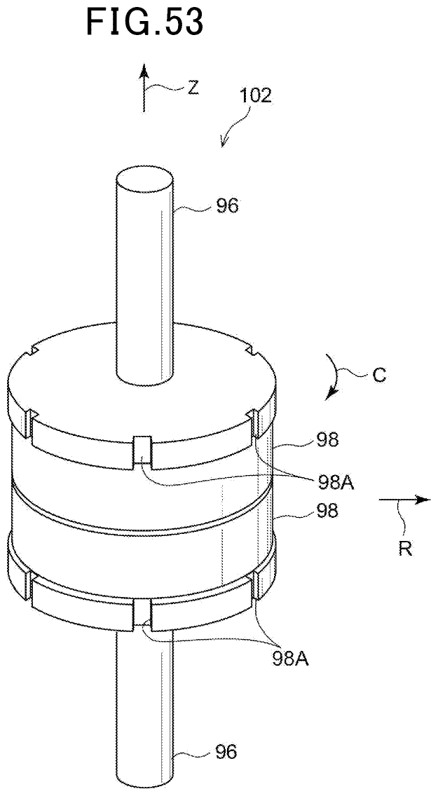

In the case of the coil assembly 32 having coil-assembly-side protrusions 34F as in the motor 68 according to the third embodiment (see FIG. 23), a jig 102 shown in FIG. 53 may be used. The jig 102 has jig-side recesses 98A, with which the coil-assembly-side protrusions 34F respectively engage, formed in the rollers 98. Using the jig 102, the coil assembly 32 of the motor 68 according to the third embodiment can be manufactured through the same steps as those described above.

### Sixteenth Embodiment

Next, a motor according to the sixteenth embodiment will be described. It should be noted that: members and parts of the motor according to the sixteenth embodiment corresponding to those of the motor 10 according to the first embodiment are designated by the same reference signs as the corresponding members and parts of the motor 10 according to the first embodiment; and description of these parts and members will be omitted hereinafter.

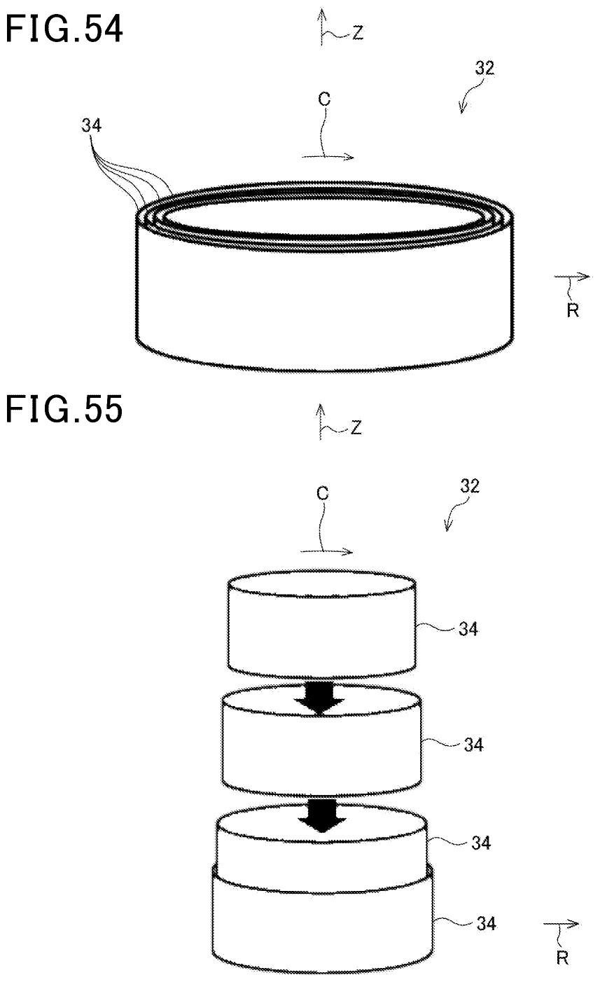

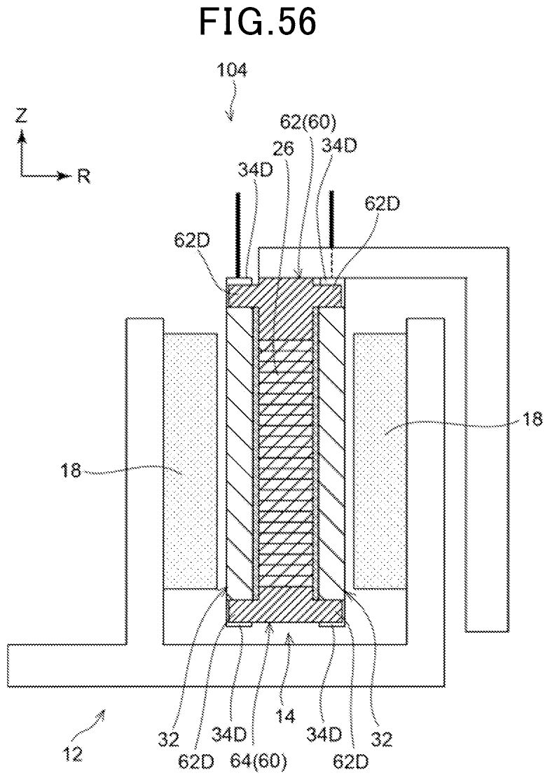

FIGS. 54 and 55 schematically show a coil assembly 32 that constitutes a part of the motor according to the sixteenth embodiment. As shown in FIGS. 54 and 55, the coil assembly 32 is composed of a plurality of band members 34 rolled in an annular shape. It should be noted that each of the annularly-rolled band members 34 may have a single layer or a plurality of layers in the radial direction. More particularly, in the present embodiment, the coil assembly 32 is composed of four band members 34.

Moreover, the four band members 34 have different inner and outer diameters from each other. By repeating the process of placing one of the band members 34 radially inside another one of the band members 34, the coil assembly 32 is formed which has four layers in the radial direction. As above, the coil assembly 32 can also be formed of a plurality of annularly-rolled band members 34. It should be noted that the coils 16 and the coil-assembly-side recesses 34D are not shown in FIGS. 54 and 55.

### Seventeenth and Eighteenth Embodiments

Next, a motor 104 according to the seventeenth embodiment and a motor 106 according to the eighteenth embodiment will be described. It should be noted that: members and parts of the motors 104 and 106 according to the seventeenth and eighteenth embodiments corresponding to those of the motor 10 according to the first embodiment are designated by the same reference signs as the corresponding members and parts of the motor 10 according to the first embodiment; and description of these parts and members will be omitted hereinafter.

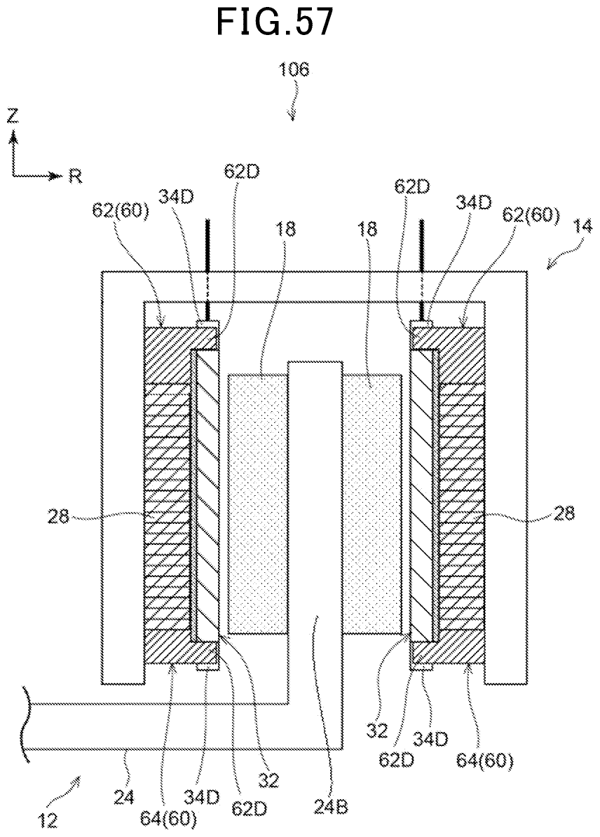

As shown in FIG. 56, the stator 14 of the motor 104 according to the seventeenth embodiment has an inner coil assembly 32 arranged radially inside the stator core 26 and an outer coil assembly 32 arranged radially outside the stator core 26. Moreover, the rotor 12 of the motor 104 according to the seventeenth embodiment has inner magnets 18 arranged radially inside the inner coil assembly 32 and outer magnets 18 arranged radially outside the outer coil assembly 32.

As shown in FIG. 57, the rotor 12 of the motor 106 according to the eighteenth embodiment has inner magnets 18 fixed to the inner circumferential surface of the second cylindrical part 24B of the rotor core 24 and outer magnets 18 fixed to the outer circumferential surface of the second cylindrical part 24B of the rotor core 24. Moreover, the stator 14 of the motor 106 according to the eighteenth embodiment has an inner stator core 26 and an inner coil assembly 32 arranged radially inside the inner magnets 18 and an outer stator core 26 and an outer coil assembly 32 arranged radially outside the outer magnets 18.

As in the motors 104 and 106 according to the seventeenth and eighteenth embodiments described above, the number and arrangement of coil assemblies 32 of the stator 14, the arrangement of magnets 18 of the rotor 12, the number of stator cores 26 of the stator 14 and the like may be set properly in consideration of the output characteristics and size required of the motor.

While the above embodiments of the present disclosure have been described, it will be understood by those skilled in the art that the present disclosure is not limited to the above embodiments, but may be carried out through various modifications without departing from the spirit of the present disclosure. Moreover, all or some of the configurations of the motors according the above embodiments may be combined with each other.

For example, although the embodiments in which the coils 16 formed on the band member 34 are star-connected have been illustrated, they may alternatively be delta-connected. Moreover, the coils 16 may be star-connected on one lap of the rolled band member 34 and delta-connected on another lap of the rolled band member 34. Furthermore, the support member main body 62A does not necessarily have the annular shape of being continuous over the range of 360°, but may have the shape of a ring having a portion thereof cut out (e.g., a C-shape). Moreover, the coil assembly support member 60 (i.e., the engagement member) or any of the engagement portions (i.e., the first to the fourth engagement portions) may be provided at only one of a first end and a second end of the start core 26 in the axial direction. Furthermore, the number of poles, the number of coils, the number of phases, the number of coils connected in series with each other, the number of coils connected in parallel with each other, and the like of the motor 10 may be set properly according to the application of the motor 10. Moreover, the configuration of the motor 10 can also be applied to an electric generator. Furthermore, the configuration of the motor 10 can also be applied to an outer rotor type brushless motor in which a rotor 12 is arranged radially outside a stator 14. Moreover, the configuration of the coil assembly 32 according to the present disclosure can also be applied to a rotor that includes a coil assembly 32.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

What is claimed is:

1. An armature comprising:
a tubular armature core;
a coil assembly arranged along the armature core and having a band member, a coil and a first engagement portion, the band member being formed of an electrically-insulative material into a band shape and rolled along a circumferential direction into an annular shape, the coil being formed of an electroconductive material to the band member, the first engagement portion being provided to the band member; and
an engagement member mounted to the armature core, the engagement member having a second engagement portion that engages with the first engagement portion and thereby positions the coil assembly with respect to the armature core.

2. The armature as set forth in claim 1, wherein:
the band member has a band member main body rolled into the annular shape;
the first engagement portion is a recess formed in the band member main body;
the engagement member has an engagement member main body formed in an annular shape; and
the second engagement portion is a protrusion that protrudes from the engagement member main body.

3. The armature as set forth in claim 1, wherein:
the band member has a band member main body rolled into the annular shape;
the first engagement portion is a protrusion that protrudes from the band member main body;
the engagement member has an engagement member main body formed in an annular shape; and
the second engagement portion is a recess formed in the engagement member main body.

4. The armature as set forth in claim 1, wherein:
the engagement member further has a third engagement portion; and
the armature core has a fourth engagement portion that engages with the third engagement portion and thereby positions the engagement member with respect to the armature core.

5. The armature as set forth in claim 4, wherein:
the engagement member has an engagement member main body formed in an annular shape;
the third engagement portion is a protrusion that protrudes from the engagement member main body;
the armature core has an armature core main body formed in a cylindrical shape; and
the fourth engagement portion is a recess formed in the armature core main body.

6. The armature as set forth in claim 4, wherein:
the engagement member has an engagement member main body formed in an annular shape;
the third engagement portion is a recess formed in the engagement member main body;
the armature core has an armature core main body formed in a cylindrical shape; and
the fourth engagement portion is a protrusion that protrudes from the armature core main body.

7. The armature as set forth in claim 4, wherein:
the engagement member has an engagement member main body formed in an annular shape;
the third engagement portion is a step portion formed in the engagement member main body;
the armature core has a cylindrical armature core main body formed by laminating a core-forming sheet in a plurality of layers in an axial direction while winding it in the circumferential direction into an annular shape; and
the fourth engagement portion is a step portion formed between the armature core main body and an end portion of the core-forming sheet.

8. The armature as set forth in claim 4, wherein:
the engagement member has an engagement member main body formed in an annular shape;
the third engagement portion is a recess formed in the engagement member main body;
the armature core has a cylindrical armature core main body formed by laminating a core-forming sheet in a plurality of layers in an axial direction; and
the fourth engagement portion is an end portion of the core-forming sheet which is bent to protrude from the armature core main body toward the engagement member.

9. The armature as set forth in claim 1, wherein:
the armature core is formed, by laminating a plurality of core-forming sheets in an axial direction, into the cylindrical shape; and
at least one of the core-forming sheets engages with the coil assembly.

10. The armature as set forth in claim 1, wherein:
the coil has an axial central portion constituting a vertical portion, and axial end portions constituting coil end portions respectively on opposite axial sides of the vertical portion;
the coil assembly is arranged along a radially inner or radially outer surface of the armature core; and
the engagement member is formed of a nonmagnetic material, arranged along an axial end face of the-armature core, and located at a position not radially overlapping the vertical portion.

11. The armature as set forth in claim 1, wherein:
between the coil assembly and the armature core, there is provided an insulator; and
the insulator is formed integrally with the engagement member.

12. The armature as set forth in claim 1, wherein:
a sensor is mounted to the engagement member.

13. The armature as set forth in claim 1, wherein:
the band member is rolled along the circumferential direction in a plurality of laps to have a plurality of layers in a radial direction;
as the first engagement portion, in each of the layers of the band member, there are provided a plurality of first engagement portions at predetermined intervals in the circumferential direction; and
the circumferential intervals between the first engagement portions provided in one of the layers are set to be greater than the circumferential intervals between the first engagement portions provided in another of the layers which is located radially inside the one of the layers, so that the circumferential positions of the first engagement portions provided in the one of the layers respectively coincide with the circumferential positions of the first engagement portions provided in the another of the layers.

14. An armature comprising:
a tubular armature core;
a coil assembly arranged along the armature core and having a band member, a coil and a first engagement portion, the band member being formed of an electrically-insulative material into a band shape and rolled along a circumferential direction into an annular shape, the coil being formed of an electroconductive material to the band member, the first engagement portion being provided to the band member; and
an engagement member mounted to the armature core, the engagement member having a second engagement portion that engages with the first engagement portion and thereby positions the coil assembly with respect to the armature core,
wherein:
the engagement member and the armature core are arranged in alignment with each other in an axial direction.

15. An armature comprising:
a tubular armature core;
a coil assembly arranged along the armature core and having a band member, a coil and a first engagement portion, the band member being formed of an electrically-insulative material into a band shape and rolled along a circumferential direction into an annular shape, the coil being formed of an electroconductive material to the band member, the first engagement portion being provided to the band member; and
an engagement member mounted to the armature core, the engagement member having a second engagement portion that engages with the first engagement portion and thereby positions the coil assembly with respect to the armature core,
wherein:
the armature core is arranged radially outside the coil assembly.

16. A rotating electric machine comprising:
a stator; and
a rotor,
wherein:
one of the stator and the rotor includes the armature as set forth in claim 1, and the other of the stator and the rotor has magnets arranged to radially face the coil assembly.
